(19) United States
(12) Patent Application Publication
(10) Pub. No.: US 2025/0094626 A1
(43) Pub. Date: Mar. 20, 2025

(54) CONCEALMENT DEVICE, ESTIMATION SYSTEM, AND CONCEALMENT METHOD

(71) Applicants: NEC CORPORATION, Tokyo (JP); UNIVERSITY OF TSUKUBA, Tsukuba-shi (JP)

(72) Inventors: Kazuya KAKIZAKI, Tokyo (JP); Junki MORI, Tokyo (JP); Isamu TRANISHI, Tokyo (JP); Toshinori ARAKI, Tokyo (JP); Jun SAKUMA, Tsukuba-shi (JP)

(73) Assignees: NEC CORPORATION, Tokyo (JP); UNIVERSITY OF TSUKUBA, Tsukuba-shi (JP)

(21) Appl. No.: 18/830,701

(22) Filed: Sep. 11, 2024

(30) Foreign Application Priority Data
Sep. 20, 2023 (JP) 2023-152346

(51) Int. Cl. G06F 21/62; G06F 40/166

(52) U.S. Cl. CPC G06F 21/6245; G06F 40/166

(57) ABSTRACT

A concealment device includes at least one memory configured to store instructions and at least one processor configured to execute the instructions to generate a second string in which a substring of a first string detected as a concealment target has been replaced with another substring, and input the second string to a device that outputs a response to the second string.

This application is based upon and claims the benefit of priority from Japanese patent application No. 2023-152346, filed on Sep. 20, 2023, the disclosure of which is incorporated herein in its entirety by reference.

### TECHNICAL FIELD

The present disclosure relates to a concealment device, an estimation system, and a concealment method.

### BACKGROUND ART

There are cases where systems, such as large language models, which output string responses to string inputs, are employed.

For example, Japanese Patent No. 7,313,757 discloses a text generation device that creates prompts for a large language model, ensuring the character count limit for input to the large language model.

### SUMMARY

It is preferable to enable conversion of an input string to a system that outputs a string in response to an input of a string, into a string in which concealment target information is concealed.

An example object of the present disclosure is to provide a concealment device, an estimation device, a display device, an estimation system, a concealment method, an estimation method, and a program capable of solving the above problem.

According to a first example aspect of the present disclosure, a concealment device generates a second string in which a substring of a first string detected as a concealment target has been replaced with another substring, and inputs the second string to a device that outputs a response to the second string.

According to a second example aspect of the present disclosure, an estimation device estimates a fourth string, based on a third string being a response to a second string in which a substring of a first string detected as a concealment target has been replaced with another substring, the fourth string being a response to the first string in which the substring detected as the concealment target has not been replaced.

According to a third example aspect of the present disclosure, a display device displays a second string in which a substring of a first string corresponding to a concealment target has been replaced with another substring.

According to a fourth example aspect of the present disclosure, a display device displays a fourth string, based on a third string being a response to a second string in which a substring of a first string corresponding to a concealment target has been replaced with another substring, the fourth string being a response to the first string in which the substring corresponding to the concealment target has not been replaced.

According to a fifth example aspect of the present disclosure, an estimation system generates a second string in which a substring of a first string detected as a concealment target has been replaced with another substring, and estimates a fourth string, based on a third string being a response to a second string, the fourth string being a response to the first string in which the substring detected as the concealment target has not been replaced.

According to a sixth example aspect of the present disclosure, a concealment method executed by a computer includes: generating a second string in which a substring of a first string detected as a concealment target has been replaced with another substring; and inputting the second string to a device that outputs a response to the second string.

According to a seventh example aspect of the present disclosure, an estimation method executed by a computer includes estimating a fourth string, based on a third string being a response to a second string in which a substring of a first string detected as a concealment target has been replaced with another substring, the fourth string being a response to the first string in which the substring detected as the concealment target has not been replaced.

According to an eighth example aspect of the present disclosure, an estimation method executed by a computer includes: generating a second string in which a substring of a first string detected as a concealment target has been replaced with another substring; and estimating a fourth string, based on a third string being a response to a second string, the fourth string being a response to the first string in which the substring detected as the concealment target has not been replaced.

According to a ninth example aspect of the present disclosure, a program causes a computer to execute: generating a second string in which a substring of a first string detected as a concealment target has been replaced with another substring; and inputting the second string to a device that outputs a response to the second string.

According to a tenth example aspect of the present disclosure, a program causes a computer to execute estimating a fourth string, based on a third string being a response to a second string in which a substring of a first string detected as a concealment target has been replaced with another substring, the fourth string being a response to the first string in which the substring detected as the concealment target has not been replaced.

According to the present disclosure, it is possible to convert an input string to a system that outputs a string in response to an input of a string, into a string in which concealment target information is concealed.

### BRIEF DESCRIPTION OF THE DRAWINGS

FIG. 1 is a diagram showing a configuration example of a system according to at least one of the example embodiments.

FIG. 2 is a diagram showing an example of a procedure of processing performed by an estimation system according to at least one of the example embodiments.

FIG. 3 is a diagram showing a configuration example of a concealment device according to at least one of the example embodiments.

FIG. 4 is a diagram showing a configuration example of an estimation device according to at least one of the example embodiments.

FIG. 5 is a diagram showing an example of data input/output in a case where the estimation system according to at least one of the example embodiments estimates an ideal response through string replacement.

FIG. 6 is a diagram showing a configuration example of a learning system in a case where training a neural network included in an estimation unit according to at least one of the example embodiments.

FIG. 7 is a diagram showing a configuration example of a learning control device according to at least one of the example embodiments.

FIG. 8 is a diagram showing an example of data input/output in the learning system in a case where training the neural network included in the estimation unit according to at least one of the example embodiments.

FIG. 9 is a diagram showing an example of data input/output in the estimation system in a case where the estimation unit according to at least one of the example embodiments estimates an ideal response.

FIG. 10 is a diagram showing a configuration example of the learning system in a case where additional learning is performed for a response device according to at least one of the example embodiments.

FIG. 11 is a diagram showing an example of data input/output in the learning system in a case where additional learning is performed for the response device according to at least one of the example embodiments.

FIG. 12 is a diagram showing another configuration example of the concealment device according to at least one of the example embodiments.

FIG. 13 is a diagram showing another configuration example of the estimation device according to at least one of the example embodiments.

FIG. 14 is a diagram showing a configuration example of a display device according to at least one of the example embodiments.

FIG. 15 is a diagram showing another configuration example of the display device according to at least one of the example embodiments.

FIG. 16 is a diagram showing a configuration example of the estimation system according to at least one of the example embodiments.

FIG. 17 is a diagram showing an example of a processing procedure in a concealment method according to at least one of the example embodiments.

FIG. 18 is a diagram showing an example of a processing procedure in an estimation method according to at least one of the example embodiments.

FIG. 19 is a diagram showing another example of the processing procedure in the estimation method according to at least one of the example embodiments.

FIG. 20 is a diagram showing a configuration example of a computer according to at least one of the example embodiments.

### EXAMPLE EMBODIMENT

Hereinafter, example embodiments of the present disclosure will be described, however, the present disclosure within the scope of the claims is not limited by the following example embodiments. Furthermore, not all the combinations of features described in the example embodiments are essential for the solving means of the disclosure.

In the following, a character that is supposed to have a macron attached thereabove may be denoted with a superscript “-” after the character. For example, f with a macron may also be expressed as f.

### First Example Embodiment

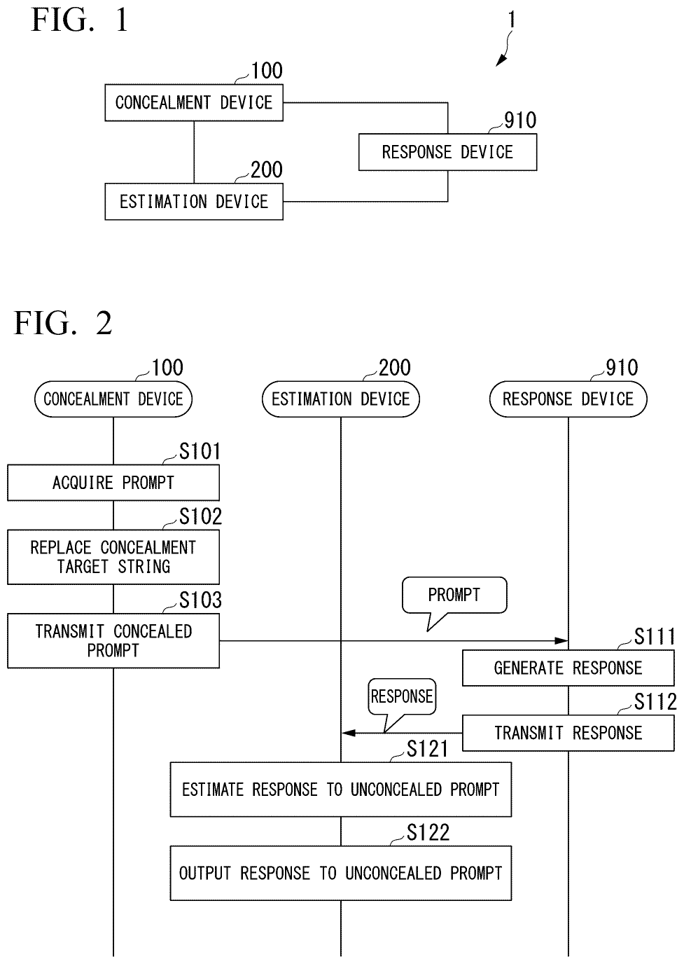

FIG. 1 is a diagram showing a configuration example of a system according to at least one of the example embodiments. In the configuration shown in FIG. 1, an estimation system 1 includes a concealment device 100 and an estimation device 200.

Also shown in FIG. 1 is a response device 910.

The response device 910 may be configured as a part of the estimation system 1 or may be configured as an external unit of the estimation system 1.

Moreover, the concealment device 100, the estimation device 200, and the response device 910, or any combination of these may be configured as a single unit. For example, the concealment device 100 and the estimation device 200 may be configured as a single device.

Upon receiving a string input, the response device 910 outputs a string. The response device 910 corresponds to an example of a system that outputs a string in response to an input of a string.

A string input to the response device 910, or a string that is the origin of the string input to the response device 910, is also referred to as prompt. The string referred to as the origin of the string input to the response device 910 is the string before any processing is performed, in cases where the string has undergone processing and the processed string is input to the response device 910.

The string output by the response device 910 is also referred to as response.

The response device 910 may be configured, using a computer.

The response device 910 may be configured as a large language model (LLM). A large language model is a type of language model.

For example, the response device 910 may be configured to output a natural language response to an input of a natural language query. Also, the input to the response device 910 does not need to be in the form of a query. For example, the response device 910 may receive a natural language sentence as input and respond with the emotion conveyed by the sentence. Moreover, the input to the response device 910, the output from the response device 910, or both, do not need to be limited to natural language strings. For example, the response device 910 may output a program (source code).

However, the response device 910 is not limited to being configured as a large language model. Various types of implementations that output a string upon receiving a string input while the input string may contain concealment target substrings, can be used as the response device 910.

The concealment device 100 conceals prompts. Specifically, the concealment device 100 detects a concealment target substring in a prompt, and replaces the detected substring with another substring. The concealment device 100 then inputs the prompt after such replacement, to the response device 910.

The concealment device 100 may be configured, using a computer.

The prompt after replacement (the prompt in which the substring detected as the concealment target has been replaced with another substring) is also referred to as a concealed prompt. The concealed prompt corresponds to an example of a second string. The concealed prompt also corresponds to an example of a sixth string.

The prompt before replacement (the prompt before the replacement of the substring that is the concealment target) is also referred to as an unconcealed prompt. The unconcealed prompt corresponds to an example of a first string. The unconcealed prompt also corresponds to an example of a fifth string.

The estimation device 200 estimates the response of the response device 910 to an unconcealed prompt, based on the response of the response device 910 to the concealed prompt.

The estimation device 200 may be configured, using a computer.

The response of the response device 910 to the concealed prompt corresponds to an example of a third string. The response of the response device 910 to the concealed prompt also corresponds to an example of a seventh string.

The response of the response device 910 to the unconcealed prompt corresponds to an example of a fourth string. The response of the response device 910 to the unconcealed prompt also corresponds to an example of an eighth string.

FIG. 2 is a diagram showing an example of a procedure of processing performed by the estimation system 1.

In the processing of FIG. 2, the concealment device 100 acquires a prompt (Step S101). The prompt that the concealment device 100 acquires in Step S101 corresponds to an unconcealed prompt.

Next, the concealment device 100 replaces the concealment target substring in the prompt acquired in Step S101 with another substring (Step S102). Specifically, the concealment device 100 detects a substring that corresponds to a string designated as a concealment target, from the prompt acquired in Step S101. Then, the concealment device 100 replaces the detected substring with another substring.

The concealment device 100 then transmits the concealed prompt to the response device 910 (Step S103).

Having received the concealed prompt from the concealment device 100, the response device 910 generates a response to the received concealed prompt (Step S111).

Then, the response device 910 transmits the generated response to the estimation device 200 (Step S112). The response transmitted by the response device 910 in Step S112 corresponds to a response to the concealed prompt.

Having received the response from the response device 910, the estimation device 200 estimates a response to the unconcealed prompt based on the received response (Step S121).

The estimation device 200 then outputs the estimated response to the unconcealed prompt (Step S122). The estimated response is also referred to as an estimated value of response.

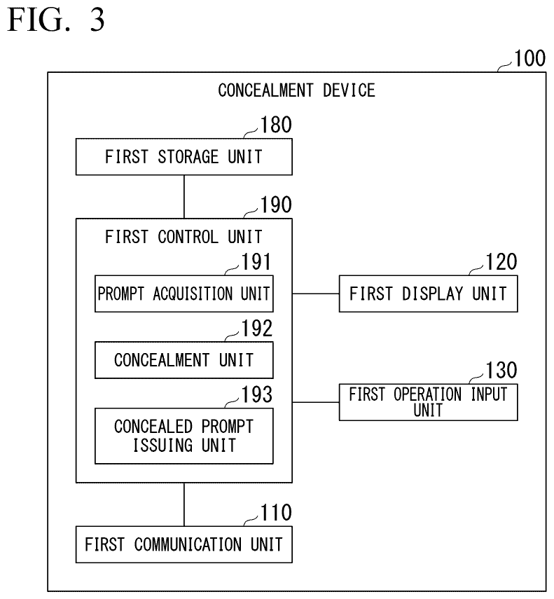

FIG. 3 is a diagram showing a configuration example of the concealment device 100. In the configuration shown in FIG. 3, the concealment device 100 includes a first communication unit 110, a first display unit 120, a first operation input unit 130, a first storage unit 180, and a first control unit 190. The first control unit 190 includes a prompt acquisition unit 191, a concealment unit 192, and a concealed prompt issuing unit 193.

The first communication unit 110 communicates with other devices according to the control of the first control unit 190. For example, the first communication unit 110 may transmit a concealed prompt to the response device 910.

The first display unit 120 includes a display screen such as a liquid crystal panel or a Light Emitting Diode (LED) panel for example, and displays various images according to the control of first control unit 190. For example, the first display unit 120 may display a concealed prompt and an unconcealed prompt.

The first display unit corresponds to an example of the display means. The concealment device 100 corresponds to an example of the display device in that it includes the first display unit 120.

The first operation input unit 130 includes input devices such as a keyboard and a mouse, and receives user operations. For example, the first operation input unit 130 may receive a user operation for inputting a prompt. The prompt here corresponds to an unconcealed prompt.

The first storage unit 180 stores various types of data. The first storage unit 180 is configured using a memory storage device included in the concealment device 100.

For example, the first storage unit 180 may store data for detecting a concealment target string.

The first storage unit 180 may store a list of strings to be detected as concealment target substrings, as data for detecting concealment target substrings. A string to be detected as a concealment target substring is also referred to as replacement target string.

Alternatively, the first storage unit 180 may store, as data for detecting concealment target substrings, a replacement rule indicating a replacement target string and a string that is to replace the string. The string that is to replace the replacement target string is also referred to as replacement string.

The first control unit 190 controls each unit of the concealment device 100 and executes various processes. Functions of the first control unit 190 may be executed by a Central Processing Unit (CPU) included in the concealment device 100 reading out a program from the first storage unit 180 and executing the program.

The prompt acquisition unit 191 acquires a prompt. The prompt acquired by the prompt acquisition unit 191 corresponds to an unconcealed prompt.

The method used by the prompt acquisition unit 191 to acquire a prompt is not limited to a particular method. For example, the first operation input unit 130 may receive a user operation for inputting a prompt, and the prompt acquisition unit 191 may generate a string according to the user operation, thereby acquiring the prompt. Alternatively, the first communication unit 110 may receive a prompt from another device, and the prompt acquisition unit 191 may extract the prompt from the data received by the first communication unit 110.

The concealment unit 192 conceals a prompt. Specifically, the concealment unit 192 detects a concealment target substring from the prompt acquired by the prompt acquisition unit 191. Then, the concealment unit 192 replaces the detected substring with another substring.

The concealment unit 192 corresponds to an example of the concealment means. The prompt after replacement performed by the concealment unit 192 corresponds to a concealed prompt.

The concealed prompt issuing unit 193 transmits the prompt after replacement performed by the concealment unit 192, to the response device 910 via the first communication unit 110.

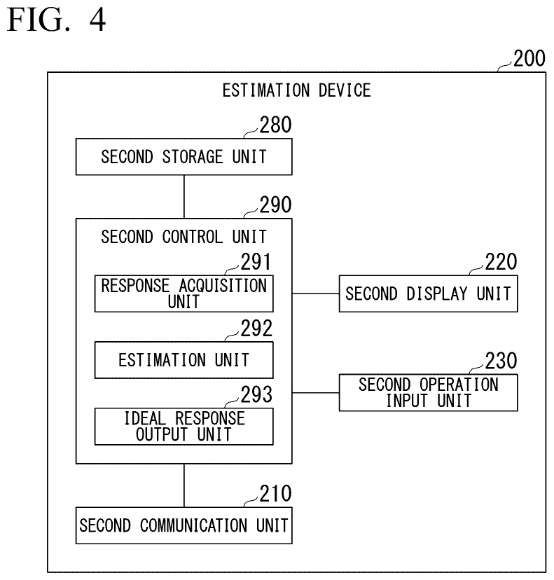

FIG. 4 is a diagram showing a configuration example of the estimation device 200. In the configuration shown in FIG. 4, the estimation device 200 includes a second communication unit 210, a second display unit 220, a second operation input unit 230, a second storage unit 280, and a second control unit 290. The second control unit 290 includes a response acquisition unit 291, an estimation unit 292, and an ideal response output unit 293.

The second communication unit 210 communicates with other devices according to the control of the second control unit 290. For example, the second communication unit 210 may receive from the response device 910 a response to a concealed prompt.

The second display unit 220 includes a display screen such as a liquid crystal panel or an LED panel for example, and displays various images according to the control of second control unit 290. For example, the second display unit 220 may display a response to a concealed prompt and the estimated value of a response to the unconcealed prompt.

The second display unit 220 corresponds to an example of the display means. The estimation device 200 corresponds to an example of the display device in that it includes the second display unit 220.

The second operation input unit 230 includes input devices such as a keyboard and a mouse, and receives user operations. For example, the second operation input unit 230 may receive a user operation that specifies a method for outputting the estimated value of a response to an unconcealed prompt.

The second storage unit 280 stores various types of data. The second storage unit 280 is configured using a storage device included in the estimation device 200.

For example, in the case where the estimation device 200 replaces a substring of a response from the response device 910, which corresponds to a string after replacement performed by the concealment device 100, with the string before the replacement of the string after the replacement, the second storage unit 280 may preliminarily store data indicating the post-replacement string and the pre-replacement string of the replaced string.

Alternatively, in the case where the estimation device 200 estimates a response to an unconcealed prompt using a machine learning model, the second storage unit 280 may preliminarily store the machine learning model.

The second control unit 290 controls each unit of the estimation device 200 and executes various processes. Functions of the second control unit 290 are executed by the CPU included in the estimation device 200 reading out a program from the second storage unit 280 and executing the program.

The response acquisition unit 291 acquires a response of the response device 910 to the concealed prompt. For example, the second communication unit 210 may receive a response from the response device 910, and the response acquisition unit 291 may extract the response of the response device 910 from the data received by the second communication unit 210.

The estimation unit 292 estimates a response to an unconcealed prompt, based on the response to the concealed prompt acquired by the response acquisition unit 291.

The estimation unit 292 corresponds to an example of the estimation means.

A response to an unconcealed prompt is also referred to as ideal response. A user of the estimation system 1 may use the desired response to an unconcealed prompt as the ideal response. Alternatively, in the case where a response of the response device 910 to the unconcealed prompt can be acquired, the actual response from the response device 910 may be used as the ideal response.

The ideal response output unit 293 outputs the estimated value of the ideal response estimated by the estimation unit 292. The method for the ideal response output unit 293 to output the estimated value of an ideal response is not limited to a particular method. For example, the ideal response output unit 293 may cause the second display unit 220 to display the estimated value of the ideal response. Alternatively, the ideal response output unit 293 may cause the second communication unit 210 to transmit the estimated value of the ideal response to another device, in addition to or instead of displaying the estimated value of the ideal response by means of the second display unit 220.

According to the estimation system 1, it is possible to convert an input string to a system that outputs a string in response to an input of a string, into a string in which concealment target information is concealed. Specifically, according to the estimation system 1, it is possible to conceal concealment target information contained in a prompt and transmit it to the response device 910, and it is possible to estimate an ideal response (the response of the response device 910 to a prompt in which information is not concealed).

For example, in the case where the response device 910 is provided on the cloud, such as in a case where the response device 910 is a large language model publicly available on the cloud, there is a risk of information leakage if a prompt containing information that needs to be concealed (concealment target information) is transmitted directly to the response device 910.

In contrast, in the estimation system 1, the concealment device 100 conceals information contained in the prompt that needs to be concealed, thereby reducing the risk of information leakage. Furthermore, in the estimation system 1, it is expected that the estimation device 200 can obtain the ideal response by estimating the ideal response (the response of the response device 910 to a prompt in which information is not concealed).

Concealment target information is also referred to as concealment requiring information. The concealment requiring information is not limited to any particular type of information. For example, information relating to privacy, such as personal information, may be treated as concealment requiring information, and information relating to business activities, such as trade secrets, may be treated as concealment requiring information. Also, both information relating to privacy and information relating to business activities may be treated as concealment requiring information.

The concealment of concealment requiring information and the estimation of an ideal response will now be described further.

### (Concealment Using Hash Value)

The concealment unit 192 may replace a concealment target substring with the hash value of the substring. For example, the concealment unit 192 detects a substring that corresponds to a string of a prompt designated as a concealment target. Then, the concealment unit 192 inputs the detected substring into a hash function to calculate a hash value. The concealment unit 192 replaces the detected substring of the prompt with the hash value of the substring.

The hash function used by the concealment unit 192 to calculate the hash value is not limited to a particular hash function.

Moreover, the representation format of the hash value is not limited to a particular format. For example, the concealment unit 192 may use a hash value expressed in hexadecimal numbers, or may use a hash value expressed in decimal numbers.

In order to make it more difficult for a third party to restore the original substring from the hash value, the concealment unit 192 may append a random string to the concealment target substring before calculating the hash value.

For example, if “apple” is the concealment target substring, the concealment unit 192 may input “apple10”, which is obtained by appending a random number “10” to the end of “apple”, into the hash function to calculate a hash value, and replace “apple” in the prompt with the hash value.

The position at which the concealment unit 192 appends the random string to the concealment target substring is not limited to a particular position. For example, the concealment unit 192 may append a random string to the end of the concealment target substring, or the concealment unit 192 may append a random string to the beginning of the concealment target substring. Alternatively, the concealment unit 192 may append a random string to the concealment target substring, for example, by inserting a random string between the first and second characters of the concealment target substring.

The concealment unit 192 may determine a random string for each prompt. In such a case, a different hash value is assigned to the same substring for each prompt, thereby reducing the risk of information leakage of the concealment requiring information. Also, in such a case, within a single prompt, the same substring will be replaced with the same hash value. As a result, it is expected that the response device 910 will comprehend that the same hash value indicates the same substring, and will generate and output a response with a relatively high degree of accuracy. Moreover, in the case where the response unit 910 uses in a response the hash value indicated in the prompt, the estimation device 200 can convert the hash value in the response back to the original substring. In this respect, the estimation device 200 is expected to be able to estimate the ideal response with a relatively high degree of accuracy.

Alternatively, the concealment unit 192 may determine a random string every time it detects a concealment target substring. In such a case, different hash values are assigned to the same substring within one prompt, thereby further reducing the risk of information leakage of the concealment requiring information.

In order to assist the response device 910 in recognizing the hash value, the concealment unit 192 may append a specific string to the hash value.

For example, if “apple” is the concealment target substring, the concealment target 192 may input “apple” to the hash function to calculate a hash value, append the string “Fruits:” to the beginning of the resulting hash value, and replace “apple” in the prompt with a string in the format of “Fruits: (hash value)”.

The training of the response device 910 may be performed by fine-tuning to update the parameter values of the machine learning model of the response device 910. For example, fine tuning features of the response device 910 may be made publicly available for users.

Alternatively, the training of the response device 910 may be performed using an In-Context Learning (also called Few-Shot) technique in which sample prompts and sample responses to those prompts are transmitted to the response device 910.

By pre-training the response device 910 with a string that the concealment unit 192 appends to the hash value, it is expected that the response device 910 can recognize a substring resulting from the combination of the string and the hash value with higher accuracy. This is expected to enable the response device 910 to generate a more accurate response.

For example, the response device 910 is expected to be able to comprehend through learning that a substring of the format of “Fruits: (hash value)” indicates a substring that falls into the class “Fruits”.

The string that the concealment unit 192 appends to the hash value may be a string obtained by means of a machine learning model, such as class classification using a machine learning model.

For example, the concealment unit 192 inputs the concealment target substring “apple” to the machine learning model and obtains the class classification result “Fruits”. Moreover, the concealment unit 192 inputs the substring “apple” into the hash function to calculate a hash value. Then, the concealment unit 192 appends the class classification result string “Fruits” to the beginning of the obtained hash value to acquire a string in the format of “Fruits: (hash value)”, and replaces “apple” in the prompt with the string in the format of “Fruits: (hash value)”.

### (Concealment Using Encryption)

The concealment unit 192 may replace a concealment target substring with an encrypted version of that substring.

The encryption algorithm used by the concealment unit 192 to encrypt a substring is not limited to a particular type of encryption algorithm. For example, the concealment unit 192 may use an encryption algorithm included in a symmetric key encryption method, or may use an encryption algorithm included in a public key encryption method.

Moreover, the encryption algorithm used by the concealment unit 192 may be one for which the response device 910 does not have information for decryption.

As in the case of concealment using a hash value, the concealment unit 192 may append a random string to the concealment target substring before encrypting it.

As in the case of concealment using a hash value, the concealment unit 192 may append a specific string to the encrypted substring. Also in such a case, the string that the concealment unit 192 appends to the encrypted substring may be one that the response device 910 has learned in advance. Moreover, the string that the concealment unit 192 appends to the encrypted substring may be a string obtained using, for example, a machine learning model, such as class classification using a machine learning model.

(Concealment by Replacing with Word of Same Part of Speech)

The concealment unit 192 may replace a concealment target word with a word of the same part of speech.

For example, if “apple” is the concealment target word, the concealment unit 192 replaces “apple” in the prompt with “car”, which is a noun like “apple”.

The replacement word may be designated in advance by the user.

Alternatively, the concealment unit 192 may have a dictionary and randomly select a replacement word from among words of the same part of speech as the concealment target word.

By the concealment unit 192 replacing the concealment target word with a word of the same part of speech, it is expected that the response device 910 will be able to comprehend the prompt relatively accurately and generate a response with relatively high accuracy.

### (Concealment By Word Replacement Using Feature Vectors)

The concealment unit 192 may determine the replacement word by using feature vectors.

The input and output of a feature extraction model f used by the concealment unit 192 to extract a feature vector can be expressed as shown in Expression (1).

$$f : W \to {R}^{d} \qquad ( 1 )$$

W represents a set of words. R^{d} represents the d-dimensional real space. Upon receiving an input of a word w∈W, the feature extraction model f outputs a d-dimensional real vector.

The feature extraction model f is trained to reduce the distance between the feature vectors of words that are semantically similar, and words with closer feature vectors are treated as more similar.

The concealment unit 192 replaces the concealment target word wₛ with the word w∈W ranked K-th in the order of decreasing distance dist(f(wₛ), f(w)) in the feature vector. Here, dist is a function indicating the distance between two vectors. K is an integer where k≥1. The value of K may be set by the user.

For example, suppose the concealment target word is “apple”, and the distance between the feature vector of “apple” and the feature vector of “melon” is the smallest, and the distance between the feature vector of “apple” and the feature vector of “orange” is the second smallest.

If K=1, the concealment unit 192 replaces “apple” in the prompt with “melon”. On the other hand, if K=2, the concealment unit 192 replaces “apple” in the prompt with “orange”.

Words may be classified into classes in advance, and the concealment unit 192 may replace words within a class.

For example, the word set W is divided into C classes W₁, W₂, . . . W_{C} as shown in Expression (2).

$$W = {W}_{1} ⋃ {W}_{2} ⋃ … ⋃ {W}_{C} \qquad ( 2 )$$

The entity that performs this division is not limited to a particular entity. For example, the concealment unit 192 may perform this division. Alternatively, this division may be performed by an entity other than the concealment unit 192, such as a user.

Also, the mean vector f-ᵢ of each class is calculated in advance based on Expression (3).

$$\overline{{f}_{i}} = \frac{1}{\vert {W}_{i} \vert} {\sum }_{w ∈ {W}_{i}} f ( w ) \qquad ( 3 )$$

i is an integer in the range of 1≤i≤C that indicates an identification number for identifying a class. The class identified by the identification number i is also referred to as the i-th class.

|Wᵢ| represents the number of words contained in the i-th class Wᵢ.

The entity that performs the calculation of the mean vector is not limited to a particular entity. For example, the concealment unit 192 may calculate the mean vector. Alternatively, the calculation of the mean vector may be performed by a device other than the concealment device 192, such as an external device outside the concealment device 100.

In a case where concealing a word, the concealment unit 192 detects the mean vector f-ᵢ from the mean vectors f-₁, f-₂, . . . f-_{C} for each class, which has the smallest distance dist (f-ᵢ, f(wₛ)) from the feature vector f(ws) of the concealment target word ws.

Then, based on Expression (4), the concealment unit 192 replaces the concealment target word wₛ in the prompt, with the word w∈W ranked K-th in the order of decreasing distance l of their feature vectors from the detected mean vector f-ᵢ.

$$l = dist ( \overline{{f}_{í}} , f ( w ) ) \qquad ( 4 )$$

The first storage unit 180 may preliminarily store the feature vector f(w) of each word calculated in a case where calculating Expression (3). Then, the concealment unit 192 may use the mean vector f-ᵢ of each class and the feature vector r(w) of each word stored in the first storage unit 180 in a case where calculating Expression (4).

Then, based on Expression (5) instead of Expression (4), the concealment unit 192 may replace the concealment target word wₛ in the prompt with the word w∈W ranked K-th in the order of decreasing distance l of their feature vectors from the detected mean vector f-ᵢ.

$$l = dist ( \overline{{f}_{i}} + r , f ( w ) ) \qquad ( 5 )$$

r is a vector of a d-dimensional random number, where d is the same as the dimension of the feature vector.

According to Expression (5), as with the case of using a random number in a case where calculating the hash value described above, using a random number in word selection is expected to make it more difficult for a third party to restore the original word from the word after replacement.

As with the case of using a random number in a case where calculating the hash value described above, the concealment unit 192 may determine the value of the random number vector r for each prompt. Alternatively, the concealment unit 192 may determine the value of the random number vector r every time it detects a concealment target substring.

The concealment unit 192 may acquire the representative vector for each class by means of a method other than the method of calculating the mean vector, for example, by having the user specify the representative vector for each class. For example, the user may preliminarily specify a representative word for each class. Then, the concealment unit 192 or another entity may preliminarily calculate the feature vector of the designated representative word and prepare it as the representative vector.

In a case where concealing a word, the concealment unit 192 uses the representative vector for each class instead of the mean vector for each class described above. The concealment unit 192 detects the representative vector that is closest to the feature vector f(wₛ) of the concealment target word wₛ. The concealment unit 192 then replaces the concealment target word wₛ in the prompt with the word w∈W ranked K-th in the order of decreasing distance of the feature vector from the detected representative vector.

The concealment unit 192 may use an expression in which the mean vector f-ᵢ for each class in Expression (4) is replaced with a representative vector for each class. Alternatively, the concealment unit 192 may use an expression in which the mean vector f-ᵢ for each class in Expression (5) is replaced with a representative vector for each class.

### (Concealment to Ensure Privacy)

The concealment unit 192 may employ a substring replacement of the prompt that meets a standard defined as a privacy protection standard, such as Local Differential Privacy (LDP).

For example, based on a privacy protection standard such as Metric Local Differential Privacy (MLDP) or Utility-optimized MLDP (UMLDP), the concealment unit 192 may replace a substring of the prompt using an algorithm disclosed as an algorithm that meets the privacy protection standard.

However, the privacy protection standard used by the concealment unit 192 is not limited to a particular standard.

### (Ideal Response Estimation by String Replacement)

The estimation unit 292 may convert the word replaced by the concealment unit 192, among the substrings contained in the response from the response device 910, to the word before replacement.

Here, it is assumed that the substring replaced by the concealment unit 192 is used unchanged in the response from the response device 910.

As an example, the following describes a case where the concealment unit 192 and the estimation unit 292 replace words. However, the concealment unit 192 and the estimation unit 292 may perform replacement in units of strings other than words, such as in units of phrases.

For example, a dictionary d indicating character replacement by the concealment unit 192 as shown in Expression (6) is prepared, and the concealment unit 192 and the estimation unit 292 share the dictionary d.

$$d = {\{ {w}_{r}^{i} : {w}_{o}^{i} \}}_{i = 1}^{M} \qquad ( 6 )$$

wₒ_{ⁱ} represents the i-th replacement target word.
wᵣ_{ⁱ} represents the i-th replacement word.

In a case where the estimation unit 292 uses the dictionary d, wₒ_{ⁱ} corresponds to the value in the dictionary, and wᵣ_{ⁱ} corresponds to the key in the dictionary. In a case where the response from the response device 910 contains the word wᵣ_{ⁱ}, the estimation unit 292 replaces the word wᵣ_{ⁱ} with the word wₒ_{ⁱ}.

The dictionary d may be generated in advance. Alternatively, in the case where the concealment unit 192 determines the replacement word according to a predetermined rule, the concealment unit 192 may generate the dictionary d and transmit the generated dictionary d to the estimation unit 292 via the first communication unit 110 and the second communication unit 210.

In the case where there are multiple instances of the same word wᵣ_{ⁱ} in the dictionary d, the estimation unit 292 may replace the word wᵣ_{ⁱ} contained in the response from the response device 910 with any one of the words wₒ_{ⁱ} associated with the word wᵣ_{ⁱ}. For example, the estimation unit 292 may randomly select one of multiple words wₒ_{ⁱ} associated with the word wᵣ_{ⁱ}.

Alternatively, the estimation unit 292 may replace the word wᵣ_{ⁱ} contained in the response from the response device 910 with a list of multiple wₒ_{ⁱ} associated with the word wᵣ_{ⁱ}. In such a case, the user can select one of the multiple wₒ_{ⁱ}.

In the case where a single word wᵣ_{ⁱ} is associated with multiple words wₒ_{ⁱ}, the single word wᵣ_{ⁱ} may be associated with a list of multiple words wₒ_{ⁱ} in the dictionary d.

In the case where the concealment unit 192 encrypts the concealment target word, wₒ_{ⁱ} may be a private key. In other words, the estimation unit 292 may perform decryption by inputting the encrypted word wᵣ_{ⁱ} to an encryption algorithm to which wₒ_{ⁱ} is applied as a private key. Then, the estimation unit 292 may replace the encrypted word wᵣ_{ⁱ} contained in the response from the response device 910 with the decrypted word.

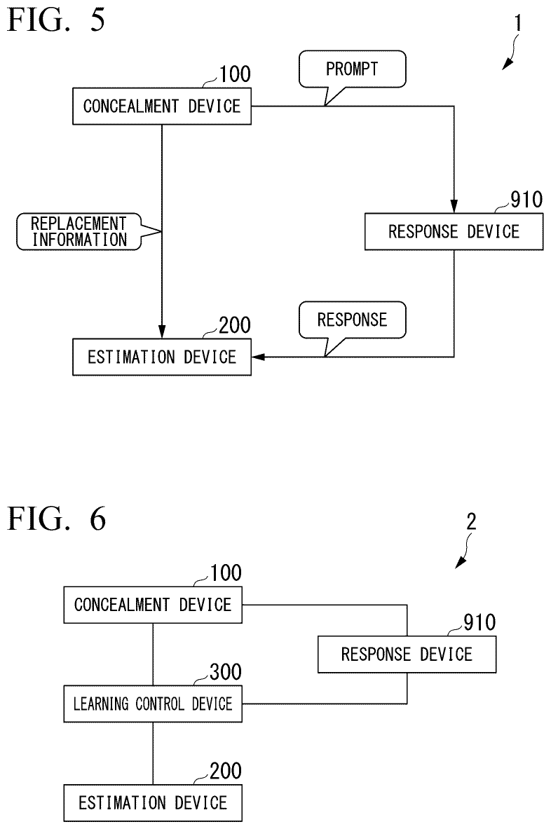

FIG. 5 is a diagram showing an example of data input/output in a case where the estimation system 1 estimates an ideal response through string replacement.

In the example of FIG. 5, the concealment device 100 transmits the concealed prompt to the response device 910. Moreover, the concealment device 100 transmits to the estimation device 200 replacement information, which is information related to the replacement of substrings performed by the concealment device 100, such as dictionary information.

The response device 910 generates a response to the concealed prompt from the concealment device 100 and transmits the generated response to the estimation device 200.

The estimation device 200 estimates an ideal response based on the replacement information from the concealment device 100 and the response from the response device 910.

### (Ideal Response Estimation Using Machine Learning Model)

The estimation unit 292 may be configured to include a machine learning model that outputs a string in response to a string input.

As an example, the following describes a case where the estimation unit 292 is configured to include a neural network. However, the machine learning model included in the estimation unit 292 is not limited to a particular type.

FIG. 6 is a diagram showing a configuration example of a learning system in a case where training the neural network included in the estimation unit 292. In the example of FIG. 6, a learning system 2 includes the concealment device 100, the estimation device 200, a learning control device 300, and the response device 910.

Of the units shown in FIG. 6, ones corresponding to those in FIG. 1 and having the same functions are given the same reference signs (100, 200, 910), and detailed descriptions thereof are omitted.

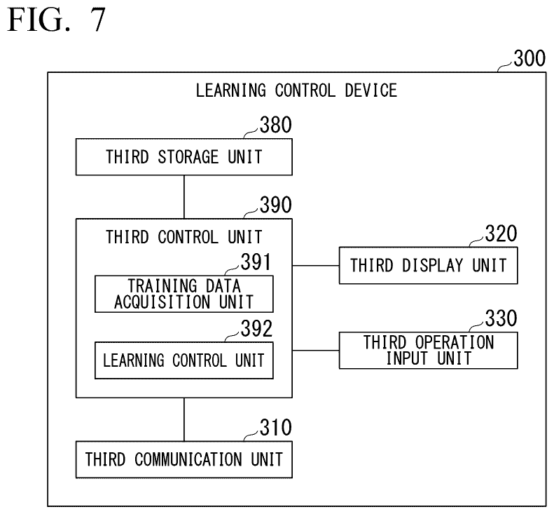

FIG. 7 is a diagram showing a configuration example of the learning control device 300. In the configuration shown in FIG. 7, the learning control device 300 includes a third communication unit 310, a third display unit 320, a third operation input unit 330, a third storage unit 380, and a third control unit 390. The third control unit 390 includes a training data acquisition unit 391 and a learning control unit 392.

The learning control device 300 controls the training of the neural network included in the estimation unit 292.

The learning control device 300 may be configured, using a computer.

The third communication unit 310 communicates with other devices according to the control of the third control unit 390. For example, in a case where the learning control device 300 accumulates training data, the third communication unit 310 may transmit a prompt to the response device 910 and receive a response.

The third display unit 320 includes a display screen such as a liquid crystal panel or an LED panel for example, and displays various images according to the control of third control unit 390. For example, the third display unit 320 may display various information related to training, such as the progress of training of the neural network.

The third operation input unit 330 includes input devices such as a keyboard and a mouse, and receives user operations. For example, the third operation input unit 330 may receive a user operation for making settings related to training, such as a learning rate.

The third storage unit 380 stores various types of data. The third storage unit 380 is configured using a memory storage device included in the learning control device 300.

For example, the third storage unit 380 may store training data for training the neural network.

The third control unit 390 controls each unit of the learning control device 300 and executes various processes. Functions of the third control unit 390 are executed by the CPU included in the learning control device 300 reading out a program from the third storage unit 380 and executing the program.

The training data acquisition unit 391 acquires training data.

For example, the user of the estimation system 1 prepares a set of pairs of prompts t_{c} and ideal responses y_{c} to the prompts t_{c} as shown in Expression (7).

$${\{ {( {t}_{c} , {y}_{c} )}_{í} \}}_{i = 1}^{N} \qquad ( 7 )$$

The concealment device 100 transmits the prompt concealed in response to the prompt t_{c} to the response device 910.

Then, the training data acquisition unit 391 generates training data as shown in Expression (8).

$$\{ concat {\{ {( {t}_{c} , E ( {t}_{c} ) , f ( E ( {t}_{c} ) ) )}_{i} , {y}_{c}^{i} \}}_{i = 1}^{N} \qquad ( 8 )$$

Here, E represents the conversion performed by the concealment unit 192 (substring concealment). E(t_{c}) represents the prompt after conversion performed by the concealment unit 192. f represents a response of the response device 910. f(E(t_{c})) represents the response of the response device 910 to the prompt after conversion performed by the concealment unit 192.

“concat” refers to the concatenation of strings. In “concat”, multiple strings are concatenated into a single string. In a case where concatenating strings using “concat”, the training data acquisition unit 391 may insert a special character indicating a string separation, such as “[SEP]”, between the strings.

y_{c}_{ⁱ} expressly indicates the ideal response y_{c} with the data identification number i.

The learning control unit 392 uses the training data acquired by the training data acquisition unit 391 to train the neural network. The learning control unit 392 inputs the string concat(t_{c}, E(t_{c}), f(E(t_{c})))ᵢ to the neural network and trains the neural network so that the neural network outputs the string y_{c}_{ⁱ}.

The neural network included in the estimation unit 292 may be configured as a language model, for example, a language model smaller than a large language model.

The learning algorithm used by the learning control unit 392 to train the neural network is not limited to a particular one. For example, the learning control unit 392 may train the neural network using backpropagation, however, the disclosure is not limited to this example. Moreover, the learning control unit 392 may train the neural network using a cross-entropy loss as a loss function, however, the disclosure is not limited to this example.

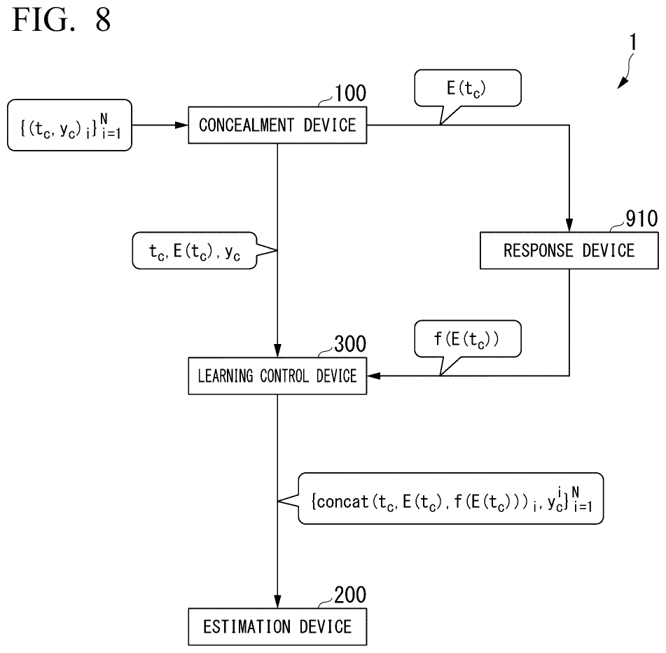

FIG. 8 is a diagram showing an example of data input/output in the learning system 2 in a case where training the neural network included in the estimation unit 292.

In the example of FIG. 8, for example, the user of the estimation system 1 prepares a set of pairs {(t_{c}, y_{c})ᵢ}ᵢ₌₁^{N} of a prompt t_{c} and an ideal response y_{c} to the prompt t_{c}. Then, the concealment device 100 transmits to the response device 910 a prompt E(t_{c}) obtained by concealing the prompt t_{c}.

Moreover, the concealment device 100 transmits to the learning control device 300 the prompt t_{c}, a prompt E(t_{c}⁾ obtained by concealing the prompt t_{c}, and an ideal response y_{c} to the prompt t_{c}.

The response device 910 generates a response f(E(t_{c})) to the concealed prompt E(t_{c}) and transmits it to the learning control device 300.

The learning control device 300 uses the prompt t_{c}, the concealed prompt E(t_{c}) for the prompt t_{c}, the ideal response ye to the prompt t_{c}, and the response f(E(t_{c})) to the prompt E(t_{c}) to generate training data {concat(t_{c}, E(t_{c}), f(E(t_{c})))ᵢ, y_{c}ⁱ}ᵢ₌₁^{N}.

The learning control device 300 uses the generated training data {concat(t_{c},E(t_{c}), f(E(t_{c})))ᵢ,y_{c}ⁱ}ᵢ₌₁^{N} to train the neural network included in the estimation unit 292.

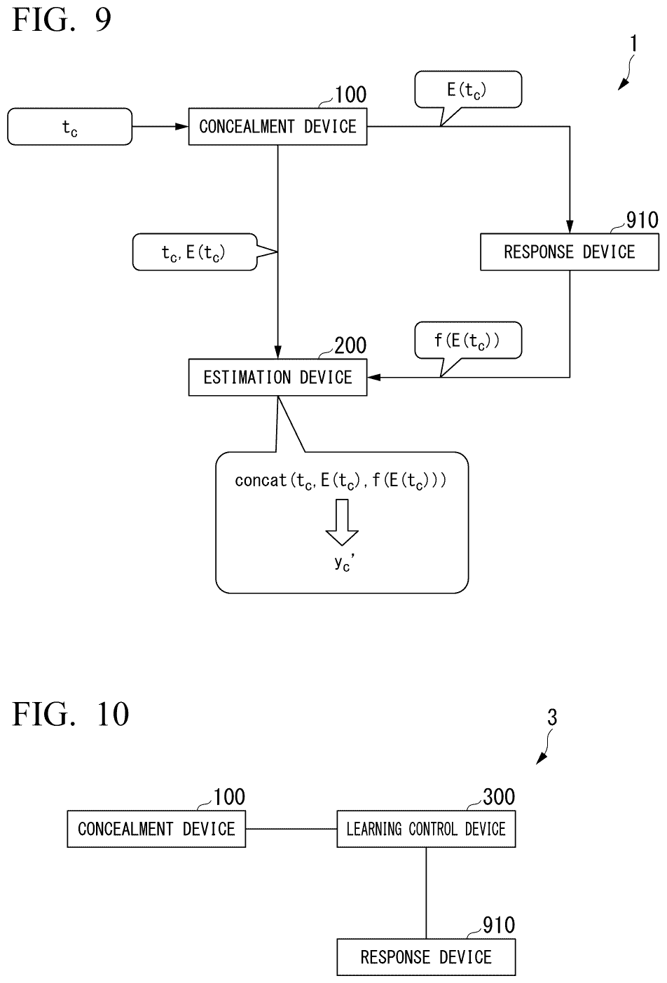

FIG. 9 is a diagram showing an example of data input/output in the estimation system 1 in a case where the estimation unit 292 estimates an ideal response.

In the example of FIG. 9, the concealment device 100 acquires the prompt t_{c} and transmits the concealed prompt E(t_{c}) for the prompt t_{c} to the response device 910.

Moreover, the concealment device 100 transmits to the estimation device 200 the prompt t_{c} and the concealed prompt E(t_{c}) for the prompt t_{c}.

The response device 910 generates the response f(E(t_{c})) to the concealed prompt E(t_{c}) and transmits it to the estimation device 200.

In the estimation device 200, the estimation unit 292 generates a string concat(t_{c}, E(t_{c}), f(E(t_{c}))) by concatenating the concealed prompt E(t_{c}) for the prompt the and the response f(E(t_{c})) to the concealed prompt E(t_{c}). The estimation unit 292 inputs the generated string to the trained neural network to calculate the estimated value y_{c}′ of the ideal response.

### (Ideal Responses Estimation Using Trained Language Model)

The estimation unit 292 may include a trained language model as the machine learning model. In such a case, the learning parameters of the language model may not be updated, but examples of input and output of the language model may be provided to the language model so that the language model uses an in-context learning technique to estimate an ideal response.

In such a case, the estimation unit 292 acquires several pairs of a sample of the string concat(t_{c}, E(t_{c}), f(E(t_{c}))) and a sample of the ideal response y_{c} to the prompt t_{c}, and provides them to the language model as input and output samples.

Then, as with the example of FIG. 9, the estimation unit 292 generates a string concat(t_{c}, E(t_{c}), f(E(t_{c}))) by concatenating the ideal response estimation target prompt t_{c}, the prompt E(t_{c}) for the prompt t_{c} concealed by the concealment device 100, and the response f(E(t_{c})) of the response device 910 to the concealed prompt E(t_{c}). The estimation unit 292 inputs the generated string into the language model to calculate the estimated value y_{c}′ of the ideal response.

The estimation unit 292 may directly input the string concat(t_{c}, E(t_{c}), f(E(t_{c}))) obtained by concatenating the ideal response estimation target prompt t_{c}, the prompt E(t_{c}) concealed for the prompt t_{c} by the concealment device 100, and the response f(E(t_{c})) of the response device 910 to the concealed prompt E(t_{c}), into the language model using a Zero-Shot technique, without providing examples of the input and output of the language model, to the language model, and calculate the estimate y_{c}′ of the ideal response.

### (Additional Learning of Response Device 910)

To help obtain the response desired by the user of the estimation system 1, additional training for the response device 910 may be performed based on the estimated value of the ideal response obtained by the estimation device 200.

FIG. 10 is a diagram showing a configuration example of a learning system in a case where additional learning is performed for the response device 910. In the example of FIG. 10, a learning system 3 includes the concealment device 100, the learning control device 300, and the response device 910.

Of the units shown in FIG. 10, ones corresponding to those in FIG. 6 and having the same functions are given the same reference signs (100, 300, 910), and detailed descriptions thereof are omitted.

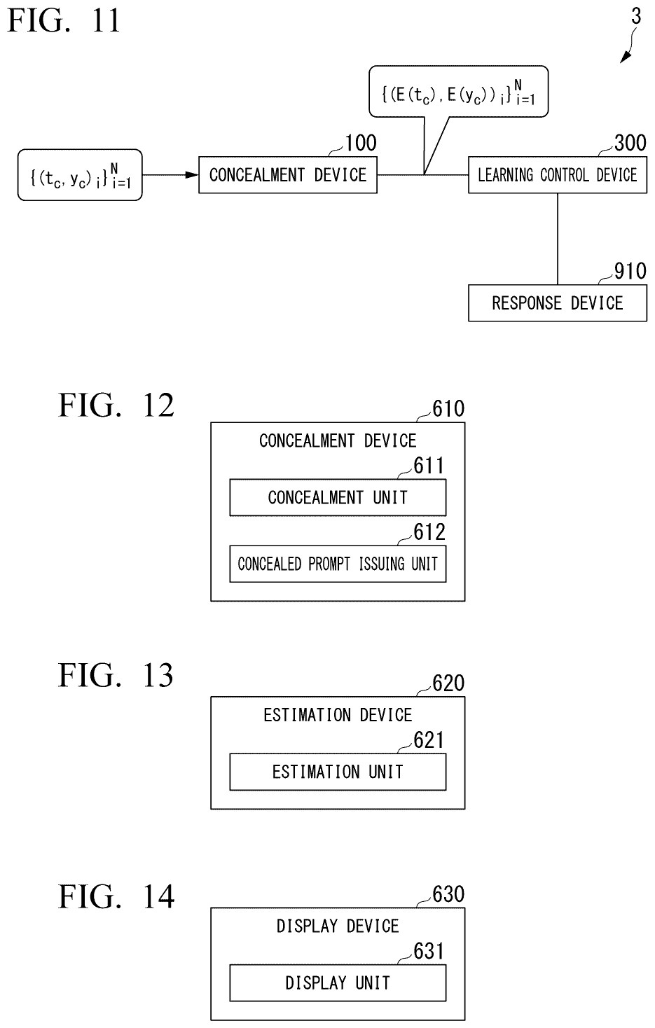

FIG. 11 is a diagram showing an example of data input/output in the learning system 3 in a case where additional learning is performed for the response device 910. In the example of FIG. 11, for example, the user of the estimation system 1 prepares a set of pairs {(t_{c}, y_{c})ᵢ}ᵢ₌₁^{N} of a prompt t_{c} and an ideal response ye to the prompt t_{c}.

Then, the concealment device 100 conceals the prompt t_{c} and the ideal response y_{c} to generate a concealed prompt E(t_{c}) and concealed response E(y_{c}), and transmits them to the learning control device 300.

The training data acquisition unit 391 of the learning control device 300 acquires training data D shown in Expression (9) based on the concealed prompt E(t_{c}) and the concealed response E(y_{c}).

$$D = {\{ {( E ( {t}_{c} ) , E ( {y}_{c} ) )}_{i} \}}_{i = 1}^{N} \qquad ( 9 )$$

The learning control unit 392 of the learning control device 300 uses the training data D to train the response device 910. The learning control unit 392 inputs the concealed prompt E(t_{c}) to the response device 910 and adjusts the learning parameters of the response device 910 so that the response device 910 outputs the concealed response E(y_{c}).

The additional training of the response device 910 performed by the learning control unit 392 can be considered as fine-tuning to adapt the response generation performed by the response device 910 to the substring replacement performed by the concealment device 100 and the estimation device 200.

The learning algorithm used by the learning control unit 392 to train the response device 910 is not limited to a particular one. For example, the learning control unit 392 may use a Low-Rank Adaptation (LoRA) to train the response device 910, however, the disclosure is not limited to this example.

According to the learning system 3, additional learning of the response device 910 can be performed using training data in which concealment requiring information is replaced with strings that cannot be understood by third parties. As a result, in the learning system 3, the risk of concealment requiring information leaking to a third party can be reduced, and the response device 910 can be trained to generate responses based on the concealment requiring information.

In particular, the concealment device 100 conceals both the prompt t_{c} and the ideal response y_{c}. Even if the concealment device 100 transmits the concealed prompt E(t_{c}) and the concealed response E(y_{c}), the risk of the concealment requiring information leaking to a third party is low.

In addition, the concealment device 100, in a case where concealing the prompt t_{c} and the ideal response y_{c}, embeds strings corresponding to the concealment target strings into the concealed prompt E(t_{c}) and the concealed response E(y_{c}). The learning control device 300 uses the concealed prompt E(t_{c}) and the concealed response E(y_{c}) to train the response device 910, whereby it is possible to train the response device 910 to output responses according to concealment requiring information.

Furthermore, according to the learning system 3, it is possible to increase the likelihood of the response device 910 comprehending prompts. Consequently, it is expected that the response device 910 will generate responses with relatively high accuracy.

For example, in a case where the concealment device 100 replaces a substring in a concealment target prompt, with a hash value, the presence of the hash values may decrease the accuracy with which the response device 910 parses the prompt. As a result, the decreased parsing accuracy may lead the response device 910 to output prompts that make it difficult to estimate the ideal response.

In contrast, with the learning control unit 392 training the response device 910 using prompts and responses that include hash values, the response device 910 is expected to generate responses to prompts containing hash values with higher accuracy.

The concealment device 100, used in the additional learning process of the response device 910, may be utilized to construct the estimation device 200 for the estimation of ideal responses.

Here, the process performed by the estimation device 200 depends on the process performed by the concealment device 100. For example, in a case where the estimation device 200 estimates an ideal response by replacing a substring, the estimation device 200 may perform a replacement of the substring that is equivalent to an inverse conversion of the replacement of the substring performed by the concealment device 100.

Therefore, the concealment device 100 and the estimation device 200 are configured to share information regarding the substring replacement, such as by sharing a dictionary. The concealment device 100 may preliminarily register in a dictionary the substring replacement performed in the conversion from the prompt t_{c} to the concealed prompt E(t_{c}) and in the conversion from the ideal response y_{c} to the concealed response E(y_{c}) for the generation of training data.

Moreover, in a case where the estimation unit 292 includes a machine learning model, in generating the string concat(t_{c}, E(t_{c}), f(E(t_{c}))) to be input to the machine learning, the prompt E(t_{c}) concealed by the concealment device 100 is used to reflect the processing of the concealment device 100 on the processing of the estimation device 200.

As described above, the concealment unit 192 generates a concealed prompt by replacing a substring of an unconcealed prompt detected as a concealment target, with another substring. The concealed prompt issuing unit 193 inputs the concealed prompt to the response device 910.

According to the concealment device 100, a prompt for the response device 910 can be converted into a prompt in which concealment target information is encrypted. Thus, according to the concealment device 100, the possibility of concealment target information being leaked can be reduced. Moreover, according to the concealment device 100, a substring detected as a concealment target is replaced with another substring, whereby it is expected that a response appropriate to the concealment target information can be obtained.

The concealment unit 192 replaces a substring of an unconcealed prompt detected as a concealment target, with the hash value of the substring.

According to the concealment device 100, with relatively simple calculations using a hash function, the replacement substring for a substring can be determined as a random string. According to the concealment device 100, in this respect, information can be more reliably concealed with relatively simple calculations.

Moreover, the concealment unit 192 replaces a substring of the first string detected as a concealment target, with the hash value of a string in which a random string has been appended to the substring. Thus, according to the concealment device 100, the possibility of concealment target information being leaked can be further reduced.

The concealment unit 192 replaces a substring of an unconcealed prompt detected as a concealment target, with a substring in which a predetermined string is appended to the hash value of the substring.

According to the concealment device 100, it is possible to assist the response device 910 in recognizing the hash values. In particular, according to the concealment device 100, by appending a predetermined string to the hash value, it is possible to provide the response device 910 with information for recognizing the hash value.

Furthermore, the response device 910 is preliminarily trained regarding the string to be appended to the hash value. According to the concealment device 100, it is expected that the response device 910 can properly recognize the hash value using the string appended to the hash value.

Moreover, the concealment unit 192 inputs a substring of an unconcealed prompt detected as a concealment target, into a trained machine learning model to acquire the predetermined string.

According to the concealment device 100, by using the machine learning model to acquire a string, it is possible to acquire a string related to the replacement target substring, and the acquired string can be appended to the hash value.

The concealment unit 192 replaces a substring of an unconcealed prompt detected as a concealment target, with a substring obtained by encrypting the substring of the unconcealed prompt. According to the concealment device 100, the encryption allows the replacement substring to be determined as a random string. According to the concealment device 100, in this respect, information can be more reliably concealed.

Moreover, the concealment unit 192 replaces a substring of an unconcealed prompt detected as a concealment target, with a substring obtained by encrypting the string in which a random string is appended to the substring of the unconcealed prompt.

Thus, according to the concealment device 100, the possibility of concealment target information being leaked can be further reduced.

The concealment unit 192 replaces a substring of an unconcealed prompt detected as a concealment target, with a substring in which a predetermined string is added to the string obtained by encrypting the substring of the unconcealed prompt.

According to the concealment device 100, it is possible to assist the response device 910 in recognizing strings. In particular, according to the concealment device 100, by appending a predetermined string to the encrypted string, it is possible to provide the response device 910 with information for recognizing encrypted strings.

Also, the response device 910 is preliminarily trained on the string that is added to the encrypted string.

According to the concealment device 100, it is expected that the response device 910 can properly recognize the encrypted string, using the string appended to the encrypted string.

Moreover, the concealment unit 192 inputs a substring of an unconcealed prompt detected as a concealment target, into a trained machine learning model to acquire the predetermined string.

According to the concealment device 100, by using the machine learning model to acquire a string, it is possible to acquire a string related to the replacement target substring, and the acquired string can be appended to the encrypted string.

Moreover, the concealment unit 192 replaces a word detected as a concealment target among words contained in an unconcealed prompt, with another word of the same part of speech.

According to the concealment device 100, it is expected that the response device 910 can comprehend a prompt with relatively high accuracy and generate a relatively accurate response because the same part of speech is maintained before and after the word replacement.

Also, the concealment unit 192 generates a feature vector of a substring of an unconcealed prompt detected as a concealment target, and selects one of the replacement target substring candidates based on the generated feature vector.

According to the concealment device 100, a substring can be replaced with another substring that is relatively similar according to certain criteria. Thus, in the concealment device 100, it is expected that the response device 910 can comprehend a prompt with relatively high accuracy and generate a relatively accurate response.

Moreover, the concealment unit 192 employs a manner of replacing a substring of an unconcealed prompt that meets the criteria defined by privacy protection standards.

According to the concealment device 100, it is possible to obtain prompts that enables privacy protection.

Furthermore, the response device 910 is trained using concealed prompts and strings in which the concealment unit 192 has performed substring replacements on the responses desired as output of the response device 910 for unconcealed prompts.

According to the concealment device 100, additional learning of the response device 910 can be performed using training data in which concealment requiring information is replaced with strings that cannot be understood by third parties. As a result, in the learning system 3, the risk of concealment requiring information leaking to third parties can be reduced, and the response device 910 can be trained to generate responses based on the concealment requiring information.

Moreover, according to the concealment device 100, it is possible to increase the likelihood of the response device 910 comprehending prompts. Consequently, it is expected that the response device 910 will generate responses with relatively high accuracy.

Furthermore, the first display unit 120 displays a concealed prompt by replacing a substring of a concealed prompt corresponding to the concealment target, with another substring.

According to the concealment device 100, the user can verify whether the concealment of information is appropriately performed by making reference to the concealed prompt.

The estimation unit 292 estimates a response to an unconcealed prompt in which a substring detected as a concealment target has not been replaced, based on the response to a concealed prompt in which the substring of the unconcealed prompt detected as a concealment target has been replaced with another substring.

According to the estimation device 200, an encrypted prompt can be used to obtain a response of the response device 910, reducing the risk of concealment requiring information leaking to third parties. Also, according to the estimation device 200, it is possible to estimate a response appropriate to concealment requiring information.

Furthermore, the estimation unit 292 replaces a substring designated as a replacement string in a substring replacement rule, among substrings of the response to a concealed prompt, with a substring designated as a pre-replacement string.

According to the estimation device 200, it is possible to perform a replacement that is equivalent to an inverse conversion of a substring replacement performed by the concealment device 100, and in this respect, it is expected that the ideal response can be estimated with high accuracy.

Moreover, in a case where there are a plurality of pre-replacement strings for one replacement string in a substring replacement rule, the estimation unit 292 replaces a substring among substrings of the response to a concealed prompt designated as a replacement string in the replacement rule, with one of a plurality of strings designated as pre-replacement strings.

According to the estimation device 200, even in a case where the replacement of substrings performed by the concealment device 100 is not in a one-to-one correspondence relationship, the ideal response can be estimated.

Furthermore, the estimation unit 292 inputs data including a prompt before replacement of a substring detected as a concealment target, the prompt after the replacement, and a response to an input of the prompt, into a machine learning model to acquire the estimated value of a response to the prompt before the replacement of the substring detected as the concealment target, the machine learning model being trained using training data where the prompt before the replacement of the substring detected as the concealment target, the prompt after the replacement, and data including the response to the input of the prompt are taken as input data, and the response to the prompt before the replacement of the substring detected as the concealment target is taken as true data.

According to the estimation device 200, a machine learning model can be used to estimate the ideal response. Thus, in the estimation device 200, for example, even in a case where the string replacement rule of the concealment device 100 cannot be obtained, the ideal response can be estimated.

Moreover, the second display unit 220 displays a response to a prompt in which a substring corresponding to a concealment target has not been replaced, and which is estimated based on the response to a concealed prompt in which the substring of an unconcealed prompt corresponding to the concealment target has been replaced with another substring.

According to the estimation device 200, the user can refer to the estimated value of an ideal response.

### Second Example Embodiment

FIG. 12 is a diagram showing another configuration example of the concealment device according to at least one of the example embodiments. In the configuration shown in FIG. 12, a concealment device 610 includes a concealment unit 611 and a concealed prompt issuing unit 612.

With such a configuration, the concealment unit 611 generates a second string in which a substring of a first string detected as a concealment target has been replaced with another substring. The concealed prompt issuing unit 612 inputs the second string to a device that outputs a response to the second string.

The concealment unit 611 corresponds to an example of the concealment means. The concealed prompt issuing unit 612 corresponds to an example of the concealed prompt issuing means.

According to the concealment device 610, it is possible to convert an input string to a device that outputs a response to the second string, into a string in which concealment target information is concealed. Thus, according to the concealment device 610, the possibility of concealment target information being leaked can be reduced. Also, according to the concealment device 610, the substring detected as a concealment target is replaced with another substring, whereby it is expected that a response appropriate to the concealment target information can be obtained.

The concealment unit 611 can be implemented using the functions of the concealment unit 192 and so forth shown in FIG. 3, for example. The concealed prompt issuing unit 612 can be implemented using the functions of the concealed prompt issuing unit 193 and so forth shown in FIG. 3, for example.

### Third Example Embodiment

FIG. 13 is a diagram showing another configuration example of the estimation device according to at least one of the example embodiments. In the configuration shown in FIG. 13, an estimation device 620 includes an estimation unit 621.

With such a configuration, the estimation unit 621 estimates a fourth string, based on a third string being a response to a second string in which a substring of a first string detected as a concealment target has been replaced with another substring, the fourth string being a response to the first string in which the substring detected as the concealment target has not been replaced.

The estimation unit 621 corresponds to an example of the estimation means.

According to the estimation device 620, the concealed second string can be used to acquire a response, reducing the risk of concealment requiring information leaking to third parties. Also, according to the estimation device 620, it is possible to estimate a response appropriate to concealment target information.

The estimation unit 621 can be implemented using the functions of the estimation unit 292 and so forth shown in FIG. 4, for example.

### Fourth Example Embodiment

FIG. 14 is a diagram showing a configuration example of a display device according to at least one of the example embodiments. In the configuration shown in FIG. 14, a display device 630 includes a display unit 631.

With such a configuration, the display unit 631 displays a second string in which a substring of a first string corresponding to a concealment target has been replaced with another substring.

The display unit 631 corresponds to an example of the display means.

According to the display device 630, the user can verify whether the concealment of information is appropriately performed by making reference to the second string.

The display unit 631 can be implemented using the functions of the first display unit 120 and so forth shown in FIG. 3, for example.

### Fifth Example Embodiment

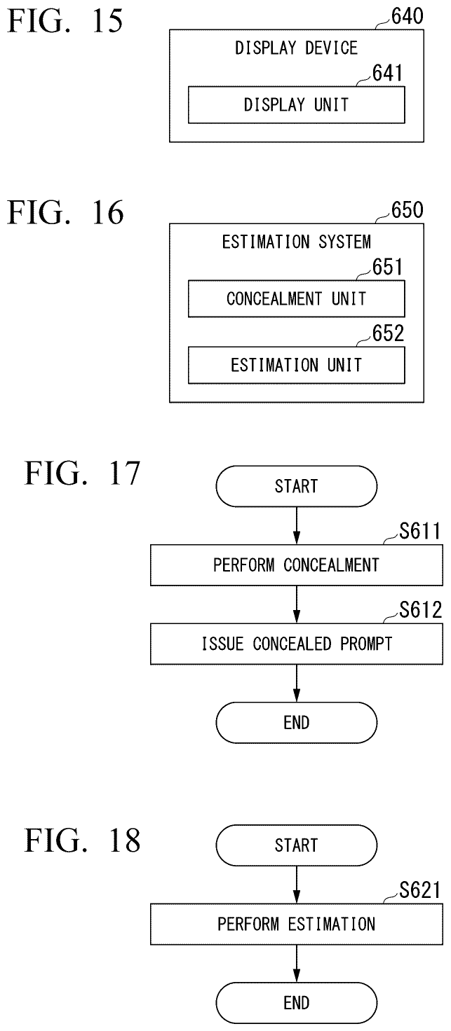

FIG. 15 is a diagram showing another configuration example of the display device according to at least one of the example embodiments. In the configuration shown in FIG. 15, a display device 640 includes a display unit 641.

With such a configuration, the display unit 641 displays a fourth string, based on a third string being a response to a second string in which a substring of a first string corresponding to a concealment target has been replaced with another substring, the fourth string being a response to the first string in which the substring corresponding to the concealment target has not been replaced.

The display unit 641 corresponds to an example of the display means.

According to the display device 640, the user can refer to the estimated fourth string. The display unit 641 can be implemented using the functions of the second display unit 220 and so forth shown in FIG. 4, for example.

### Sixth Example Embodiment

FIG. 16 is a diagram showing a configuration example of an estimation system according to at least one of the example embodiments. In the configuration shown in FIG. 16, an estimation system 650 includes a concealment unit 651 and an estimation unit 652.

With such a configuration, the concealment unit 651 generates a second string in which a substring of a first string detected as a concealment target has been replaced with another substring. The estimation unit 652 estimates a fourth string, based on a third string being a response to a second string, the fourth string being a response to the first string in which the substring detected as the concealment target has not been replaced.

According to the estimation system 650, the concealed second string can be used to acquire a response, reducing the risk of concealment requiring information leaking to third parties. Also, according to the estimation system 650, it is possible to estimate a response appropriate to concealment target information.

The concealment unit 651 can be implemented using the functions of the concealment unit 192 and so forth shown in FIG. 3, for example. The estimation unit 652 can be implemented using the functions of the estimation unit 292 and so forth shown in FIG. 4, for example.

### Seventh Example Embodiment

FIG. 17 is a diagram showing an example of a processing procedure in a concealment method according to at least one of the example embodiments.

The concealment method shown in FIG. 17 includes steps of performing concealment (Step S611) and issuing a concealed prompt (Step S612).

In the step of performing concealment (Step S611), a computer generates a second string in which a substring of a first string detected as a concealment target has been replaced with another substring.

In the step of issuing a concealed prompt (Step S612), a computer inputs the second string to a device that outputs a response to the second string.

According to the concealment method shown in FIG. 17, it is possible to convert an input string to a device that outputs a response to the second string, into a string in which concealment target information is concealed. Thus, according to the concealment method shown in FIG. 17, the possibility of concealment target information being leaked can be reduced. Also, according to the concealment method shown in FIG. 17, the substring detected as a concealment target is replaced with another substring, whereby it is expected that a response appropriate to the concealment target information can be obtained.

### Eighth Example Embodiment

FIG. 18 is a diagram showing an example of a processing procedure in an estimation method according to at least one of the example embodiments.

The estimation method shown in FIG. 18 includes a step of performing estimation (Step S621).

In the step of performing estimation (Step S621), a computer estimates a fourth string, based on a third string being a response to a second string in which a substring of a first string detected as a concealment target has been replaced with another substring, the fourth string being a response to the first string in which the substring detected as the concealment target has not been replaced.

According to the estimation method shown in FIG. 18, the concealed second string can be used to acquire a response, reducing the risk of concealment requiring information leaking to third parties. Also, according to the estimation method shown in FIG. 18, it is possible to estimate a response appropriate to concealment target information.

### Ninth Example Embodiment

FIG. 19 is a diagram showing another example of the processing procedure in the estimation method according to at least one of the example embodiments.

The estimation method shown in FIG. 19 includes steps of performing concealment (Step S631) and performing estimation (Step S632).

In the step of performing concealment (Step S631), a computer generates a second string in which a substring of a first string detected as a concealment target has been replaced with another substring.

In the step of performing estimation (Step S632), a computer estimates a fourth string, based on a third string being a response to a second string, the fourth string being a response to the first string in which the substring detected as the concealment target has not been replaced.

According to the estimation method shown in FIG. 19, the concealed second string can be used to acquire a response, reducing the risk of concealment requiring information leaking to third parties. Also, according to the estimation method shown in FIG. 19, it is possible to estimate a response appropriate to concealment target information.

The concealment device described above can also be used in a system that searches for treatment methods to be administered to a patient or medications to be administered to a patient, based on information in a medical record indicating the patient's condition. For example, an electronic medical record system that electronically manages medical records transmits the information in the electronic medical record to a search system that searches for treatment methods and medications to be administered, based on a physician's instructions. Such a search system uses text in the electronic medical record information to create a first string for searching for treatments and medications, and transmits the created string to an estimation system such as that described above. Alternatively, such a search system may include an estimation system such as that described above. The search system transmits the fourth string acquired from the estimation system to the electronic medical record system. The electronic medical record system receives the fourth string and displays the received fourth string.

The concealment device described above can also be used, for example, in a system for searching for a sentence for a criminal entity from documents showing the progress of a criminal case committed by the criminal entity. For example, a management system that electronically manages documents showing the progress of a case may transmit information about the documents showing the progress of the case to a search system that searches for sentences, at the direction of prosecutors, judges, and lawyers. Such a search system uses text in the documents showing the progress of a case to create a first string for searching for sentences, and transmits the created string to an estimation system such as that described above. Alternatively, such a search system may include an estimation system such as that described above. The search system transmits the fourth string acquired from the estimation system, to the management system. The management system receives the fourth string and displays the received fourth string.

The concealment device described above can also be used, for example, in a system for searching for products recommended for a consumer, based on the purchase history of the consumer. For example, a management system that electronically manages information representing consumers' purchase histories transmits the information on a consumer's purchase history to a search system that searches for products to recommend to the consumer. Such a search system uses text in the consumer's purchase history information to create a first string for searching for products to recommend to the consumer, and transmits the created string to the estimation system such as that described above. Alternatively, such a search system may include an estimation system such as that described above. The search system transmits the fourth string acquired from the estimation system, to the management system. The management system receives the fourth string and displays the received fourth string.

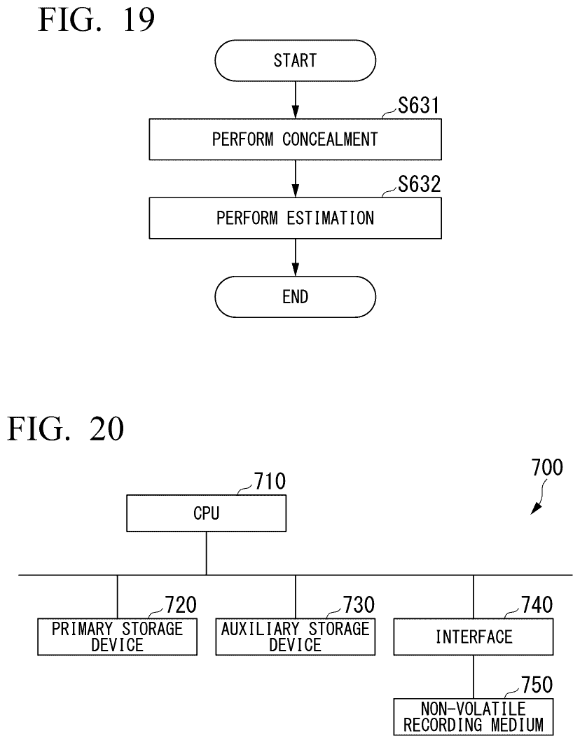

FIG. 20 is a diagram showing a configuration example of a computer according to at least one of the example embodiments. In the configuration shown in FIG. 20, a computer 700 includes a CPU 710, a primary storage device 720, an auxiliary storage device 730, an interface 740, and a non-volatile recording medium 750.

One or more of the concealment device 100, the estimation device 200, the learning control device 300, the concealment unit 610, the estimation device 620, the display device 630, the display device 640, and the estimation system 650, or part thereof may be implemented in the computer 700. In such a case, operations of the respective processing units described above are stored in the auxiliary storage device 730 in the form of a program. The CPU 710 reads out the program from the auxiliary storage device 730, loads it on the primary storage device 720, and executes the processing described above according to the program. Moreover, the CPU 710 secures, according to the program, memory storage regions corresponding to the respective storage units mentioned above, in the primary storage device 720. Communication between each device and other devices is executed by the interface 740 having a communication function and communicating under the control of the CPU 710. The interface 740 also has a port for the non-volatile recording medium 750, and reads information from the non-volatile recording medium 750 and writes information to the non-volatile recording medium 750.

In the case where the concealment device 100 is implemented in the computer 700, operations of the first control unit 190 and each component thereof are stored in the form of a program in the auxiliary storage device 730. The CPU 710 reads out the program from the auxiliary storage device 730, loads it on the primary storage device 720, and executes the processes described above, according to the program.

Also, the CPU 710 secures a memory storage region in the primary storage device 720 for the first storage unit 180, according to the program. Communication with another device performed by the first communication unit 110 is executed by the interface 740 having a communication function and operating under the control of the CPU 710. Display of images performed by the first display unit 120 is executed by the interface 740 having a display device and displaying various images under the control of the CPU 710. User operations are received through the first operation input unit 130 by the interface 740 having an input device and receiving user operations under control of the CPU 710.

In the case where the estimation device 200 is implemented in the computer 700, operations of the second control unit 290 and each component thereof are stored in the form of a program in the auxiliary storage device 730. The CPU 710 reads out the program from the auxiliary storage device 730, loads it on the primary storage device 720, and executes the processes described above, according to the program.

Also, the CPU 710 secures a memory storage region in the primary storage device 720 for the second storage unit 280, according to the program. Communication with another device performed by the second communication unit 210 is executed by the interface 740 having a communication function and operating under the control of the CPU 710. Display of images performed by the second display unit 220 is executed by the interface 740 having a display device and displaying various images under the control of the CPU 710. User operations are received through the second operation input unit 230 by the interface 740 having an input device and receiving user operations under control of the CPU 710.

In the case where the learning control device 300 is implemented in the computer 700, operations of the third control unit 390 and each component thereof are stored in the form of a program in the auxiliary storage device 730. The CPU 710 reads out the program from the auxiliary storage device 730, loads it on the primary storage device 720, and executes the processes described above, according to the program.

Also, the CPU 710 secures a memory storage region in the primary storage device 720 for the third storage unit 380, according to the program. Communication with another device performed by the third communication unit 310 is executed by the interface 740 having a communication function and operating under the control of the CPU 710. Display of images performed by the third display unit 320 is executed by the interface 740 having a display device and displaying various images under the control of the CPU 710. User operations are received through the third operation input unit 330 by the interface 740 having an input device and receiving user operations under control of the CPU 710.

In the case where the concealment device 610 is implemented in the computer 700, operations of the concealment device 611 and the concealed prompt issuing unit 612 are stored in the form of a program in the auxiliary storage device 730. The CPU 710 reads out the program from the auxiliary storage device 730, loads it on the primary storage device 720, and executes the processes described above, according to the program.

Moreover, the CPU 710 secures a memory storage region in the primary storage device 720 for the processing to be performed by the concealment device 610, according to the program. Communication with another device performed by the concealment device 610 is executed by the interface 740 having a communication function and operating under the control of the CPU 710. Interaction between the concealment device 610 and a user is executed by the interface 740 having an input device and an output device, presenting information to the user through the output device under the control of the CPU 710, and receiving user operations through the input device.

In the case where the estimation device 620 is implemented in the computer 700, operations of the estimation unit 621 are stored in the auxiliary memory storage device 730 in the form of a program. The CPU 710 reads out the program from the auxiliary storage device 730, loads it on the primary storage device 720, and executes the processes described above, according to the program.

Moreover, the CPU 710 secures a memory storage region in the primary storage device 720 for the processing to be performed by the estimation device 620, according to the program. Communication with another device performed by the estimation device 620 is executed by the interface 740 having a communication function and operating under the control of the CPU 710. Interaction between the estimation device 620 and a user is executed by the interface 740 having an input device and an output device, presenting information to the user through the output device under the control of the CPU 710, and receiving user operations through the input device.

In the case where the display device 630 is implemented in the computer 700, operations of the display device 630 are stored in the auxiliary memory storage device 730 in the form of a program. The CPU 710 reads out the program from the auxiliary storage device 730, loads it on the primary storage device 720, and executes the processes described above, according to the program.

Moreover, the CPU 710 secures a memory storage region in the primary storage device 720 for the processing to be performed by the display device 630, according to the program. Communication with another device performed by the display device 630 is executed by the interface 740 having a communication function and operating under the control of the CPU 710. Interaction between the display device 630 and a user is executed by the interface 740 having an input device and an output device, presenting information to the user through the output device under the control of the CPU 710, and receiving user operations through the input device.

In the case where the display device 640 is implemented in the computer 700, operations of the display device 640 are stored in the auxiliary memory storage device 730 in the form of a program. The CPU 710 reads out the program from the auxiliary storage device 730, loads it on the primary storage device 720, and executes the processes described above, according to the program.

Moreover, the CPU 710 secures a memory storage region in the primary storage device 720 for the processing to be performed by the display device 640, according to the program. Communication with another device performed by the display device 640 is executed by the interface 740 having a communication function and operating under the control of the CPU 710. Interaction between the display device 640 and a user is executed by the interface 740 having an input device and an output device, presenting information to the user through the output device under the control of the CPU 710, and receiving user operations through the input device.

In the case where the estimation system 650 is implemented in the computer 700, operations of the concealment unit 651 and the estimation unit 652 are stored in the auxiliary memory storage device 730 in the form of a program. The CPU 710 reads out the program from the auxiliary storage device 730, loads it on the primary storage device 720, and executes the processes described above, according to the program.

Moreover, the CPU 710 secures a memory storage region in the primary storage device 720 for the processing to be performed by the estimation system 650, according to the program. Communication with another device performed by the estimation system 650 is executed by the interface 740 having a communication function and operating under the control of the CPU 710. Interaction between the estimation system 650 and a user is executed by the interface 740 having an input device and an output device, presenting information to the user through the output device under the control of the CPU 710, and receiving user operations through the input device.

Any one or more of the programs described above may be recorded in the non-volatile recording medium 750. In such a case, the interface 740 may read the program from the non-volatile recording medium 750. Then, the CPU 710 directly executes the program read by the interface 740, or it may be temporarily stored in the primary storage device 720 or the auxiliary storage device 730 and then executed.

It should be noted that a program for executing some or all of the processes performed by the concealment device 100, the estimation device 200, the learning control device 300, the concealment device 610, the estimation device 620, the display device 630, the display device 640, and the estimation system 650 may be recorded on a computer-readable recording medium, and the program recorded on the recording medium may be read into and executed on a computer system, to thereby perform the processing of each unit. The “computer system” here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built in a computer system. The above program may be a program for realizing a part of the functions described above, and may be a program capable of realizing the functions described above in combination with a program already recorded in a computer system.

The example embodiments of the present disclosure have been described in detail with reference to the drawings. However, the specific configuration of the disclosure is not limited to the example embodiments, and may include designs and so forth that do not depart from the scope of the present disclosure.

While preferred example embodiments of the disclosure have been described and illustrated above, it should be understood that these are example embodiments of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

The whole or part of the example embodiments disclosed above can be described as, but not limited to, the following supplementary notes.

### Supplementary Note 1

A concealment device comprising:
a concealment means that generates a second string in which a substring of a first string detected as a concealment target has been replaced with another substring; and
a concealed prompt issuing means that inputs the second string to a device that outputs a response to the second string.

### Supplementary Note 2

The concealment device according to supplementary note 1, wherein the concealment means replaces the substring of the first string detected as the concealment target, with a hash value of the substring.

### Supplementary Note 3

The concealment device according to supplementary note 1, wherein the concealment means replaces the substring of the first string detected as the concealment target, with the hash value of a string in which a random string has been appended to the substring.

### Supplementary Note 4

The concealment device according to supplementary note 1, wherein the concealment means replaces the substring of the first string detected as the concealment target, with a substring in which a predetermined string has been appended to the hash value of the substring.

### Supplementary Note 5

The concealment device according to supplementary note 4, wherein the device that outputs a response upon receiving an input of the second string, is trained on the predetermined string to be appended to the hash value.

### Supplementary Note 6

The concealment device according to supplementary note 4 or 5, wherein the concealment means inputs the substring of the first string detected as the concealment target, into a trained machine learning model to acquire the predetermined string.

### Supplementary Note 7

The concealment device according to supplementary note 1, wherein the concealment means replaces the substring of the first string detected as the concealment target, with a substring obtained by encrypting the substring.

### Supplementary Note 8

The concealment device according to supplementary note 1, wherein the concealment means replaces the substring of the first string detected as the concealment target, with a substring obtained by encrypting a string in which a random string has been appended to the substring.

### Supplementary Note 9

The concealment device according to supplementary note 1, wherein the concealment means replaces the substring of the first string detected as the concealment target, with a substring in which a predetermined string has been appended to a string obtained by encrypting the substring.

### Supplementary Note 10

The concealment device according to supplementary note 9, wherein the device that outputs a response upon receiving an input of the second string, is trained on the predetermined string that has been appended to an encrypted string.

### Supplementary Note 11

The concealment device according to supplementary note 9 or 10, wherein the concealment means inputs the substring of the first string detected as the concealment target, into a trained machine learning model to acquire the predetermined string.

### Supplementary Note 12

The concealment device according to supplementary note 1, wherein the concealment means replaces a word detected as a concealment target among words contained in the first string, with another word of the same part of speech.

### Supplementary Note 13

The concealment device according to supplementary note 1, wherein the concealment means generates a feature vector of the substring of the first string detected as the concealment target, and selects one of replacement substring candidates based on the generated feature vector.

### Supplementary Note 14

The concealment device according to any one of supplementary notes 1 to 13, wherein
the concealment means employs a manner of replacing a substring of the first string that meets the criteria defined by privacy protection standards.

### Supplementary Note 15

The concealment device according to any one of supplementary notes 1 to 14, wherein
the device that outputs a response to the second string is trained using the second string, and a string obtained by the concealment means replacing a substring with a string desired as an output of the device for the first string.

### Supplementary Note 16

An estimation device comprising
an estimation means that estimates a fourth string, based on a third string being a response to a second string in which a substring of a first string detected as a concealment target has been replaced with another substring, the fourth string being a response to the first string in which the substring detected as the concealment target has not been replaced.

### Supplementary Note 17

The estimation device according to supplementary note 16, wherein the estimation means replaces a substring designated as a replacement string in a substring replacement rule, among substrings of the third string, with a substring designated as a pre-replacement string.

### Supplementary Note 18

The estimation device according to supplementary note 17, wherein in a case where there are a plurality of pre-replacement strings for one replacement string, the estimation means in a substring replacement rule, replaces a substring among substrings of the third string designated as a replacement string in the replacement rule, with one of a plurality of strings designated as pre-replacement strings.

### Supplementary Note 19

The estimation device according to supplementary note 16, wherein
the estimation means inputs data including the first string, the second string, and the third string into a machine learning model to acquire an estimated value of the fourth string, the machine learning model being trained using training data where a fifth string that is a pre-replacement string of a substring detected as a concealment target, a sixth string that is a post-replacement string, and a seventh string that is a response to an input of the sixth string are taken as input data, and an eighth string that is a response to the fifth string is taken as true data.

### Supplementary Note 20

A display device comprising
a display means that displays a second string in which a substring of a first string corresponding to a concealment target has been replaced with another substring.

### Supplementary Note 21

A display device comprising
a display means that displays a fourth string, based on a third string being a response to a second string in which a substring of a first string corresponding to a concealment target has been replaced with another substring, the fourth string being a response to the first string in which the substring corresponding to the concealment target has not been replaced.

### Supplementary Note 22

An estimation system comprising:
a concealment means that generates a second string in which a substring of a first string detected as a concealment target has been replaced with another substring; and
an estimation means that estimates a fourth string, based on a third string being a response to a second string, the fourth string being a response to the first string in which the substring detected as the concealment target has not been replaced.

### Supplementary Note 23

The estimation system according to supplementary note 22, wherein
the concealment means replaces the substring of the first string detected as the concealment target, with a hash value of the substring.

### Supplementary Note 24

The estimation system according to supplementary note 22, wherein
the concealment means replaces the substring of the first string detected as the concealment target, with the hash value of a string in which a random string has been appended to the substring.

### Supplementary Note 25

The estimation system according to supplementary note 22, wherein
the concealment means replaces the substring of the first string detected as the concealment target, with a substring in which a predetermined string has been appended to the hash value of the substring.

### Supplementary Note 26

The estimation system according to supplementary note 25, wherein
the device that outputs a response upon receiving an input of the second string, is trained on the predetermined string to be appended to the hash value.

### Supplementary Note 27

The estimation system according to supplementary note 25 or 26, wherein
the concealment means inputs the substring of the first string detected as the concealment target, into a trained machine learning model to acquire the predetermined string.

### Supplementary Note 28

The estimation system according to supplementary note 22, wherein
the concealment means replaces the substring of the first string detected as the concealment target, with a substring obtained by encrypting the substring.

### Supplementary Note 29

The estimation system according to supplementary note 22, wherein
the concealment means replaces the substring of the first string detected as the concealment target, with a substring obtained by encrypting a string in which a random string has been appended to the substring.

### Supplementary Note 30

The estimation system according to supplementary note 22, wherein
the concealment means replaces the substring of the first string detected as the concealment target, with a substring in which a predetermined string has been appended to a string obtained by encrypting the substring.

### Supplementary Note 31

The estimation system according to supplementary note 30, wherein
the device that outputs a response upon receiving an input of the second string, is trained on the predetermined string that has been appended to an encrypted string.

### Supplementary Note 32

The estimation system according to supplementary note 30 or 31, wherein
the concealment means inputs the substring of the first string detected as the concealment target, into a trained machine learning model to acquire the predetermined string.

### Supplementary Note 33

The estimation system according to supplementary note 22, wherein
the concealment means replaces a word detected as a concealment target among words contained in the first string, with another word of the same part of speech.

### Supplementary Note 34

The estimation system according to supplementary note 22, wherein
the concealment means generates a feature vector of the substring of the first string detected as the concealment target, and selects one of replacement substring candidates based on the generated feature vector.

### Supplementary Note 35

The estimation system according to any one of supplementary notes 22 to 34, wherein
the concealment means employs a manner of replacing a substring of the first string that meets the criteria defined by privacy protection standards.

### Supplementary Note 36

The estimation system according to any one of supplementary notes 22 to 35, wherein
the device that outputs a response to the second string is trained using the second string, and a string obtained by the concealment means replacing a substring with a string desired as an output of the device for the first string.

### Supplementary Note 37

The estimation system according to any one of supplementary notes 22 to 36, wherein
the estimation means replaces a substring designated as a replacement string in a substring replacement rule, among substrings of the third string, with a substring designated as a pre-replacement string.

### Supplementary Note 38

The estimation system according to any one of supplementary notes 22 to 37, wherein
in a case where there are a plurality of pre-replacement strings for one replacement string, the estimation means in a substring replacement rule, replaces a substring among substrings of the third string designated as a replacement string in the replacement rule, with one of a plurality of strings designated as pre-replacement strings.

### Supplementary Note 39

The estimation system according to any one of supplementary notes 22 to 36, wherein
the estimation means inputs data including the first string, the second string, and the third string into a machine learning model to acquire an estimated value of the fourth string, the machine learning model being trained using training data where a fifth string that is a pre-replacement string of a substring detected as a concealment target, a sixth string that is a post-replacement string, and a seventh string that is a response to an input of the sixth string are taken as input data, and an eighth string that is a response to the fifth string is taken as true data.

### Supplementary Note 40

A concealment method executed by a computer, the method comprising
generating a second string in which a substring of a first string detected as a concealment target has been replaced with another substring; and
inputting the second string to a device that outputs a response to the second string.

### Supplementary Note 41

The concealment method according to supplementary note 40, wherein
the generating the second string includes replacing the substring of the first string detected as the concealment target, with a hash value of the substring.

### Supplementary Note 42

The concealment method according to supplementary note 40, wherein
the generating the second string includes replacing the substring of the first string detected as the concealment target, with the hash value of a string in which a random string has been appended to the substring.

### Supplementary Note 43

The concealment method according to supplementary note 40, wherein
the generating the second string includes replacing the substring of the first string detected as the concealment target, with a substring in which a predetermined string has been appended to the hash value of the substring.

### Supplementary Note 44

The concealment method according to supplementary note 43, wherein
the device that outputs a response upon receiving an input of the second string, is trained on the predetermined string to be appended to the hash value.

### Supplementary Note 45

The concealment method according to supplementary note 43 or 44, wherein
the generating the second string includes inputting the substring of the first string detected as the concealment target, into a trained machine learning model to acquire the predetermined string.

### Supplementary Note 46

The concealment method according to supplementary note 40, wherein
the generating the second string includes replacing the substring of the first string detected as the concealment target, with a substring obtained by encrypting the substring.

### Supplementary Note 47

The concealment method according to supplementary note 40, wherein
the generating the second string includes replacing the substring of the first string detected as the concealment target, with a substring obtained by encrypting a string in which a random string has been appended to the substring.

### Supplementary Note 48

The concealment method according to supplementary note 40, wherein
the generating the second string includes replacing the substring of the first string detected as the concealment target, with a substring in which a predetermined string has been appended to a string obtained by encrypting the substring.

### Supplementary Note 49

The concealment method according to supplementary note 48, wherein
the device that outputs a response upon receiving an input of the second string, is trained on the predetermined string that has been appended to an encrypted string.

### Supplementary Note 50

The concealment method according to supplementary note 48 or 49, wherein
the generating the second string includes inputting the substring of the first string detected as the concealment target, into a trained machine learning model to acquire the predetermined string.

### Supplementary Note 51

The concealment method according to supplementary note 40, wherein
the generating the second string includes replacing a word detected as a concealment target among words contained in the first string, with another word of the same part of speech.

### Supplementary Note 52

The concealment method according to supplementary note 40, wherein
the generating the second string includes generating a feature vector of the substring of the first string detected as the concealment target, and selecting one of replacement substring candidates based on the generated feature vector.

### Supplementary Note 53

The concealment method according to any one of supplementary notes 40 to 52, wherein
the generating the second string includes employing a manner of replacing a substring of the first string that meets the criteria defined by privacy protection standards.

### Supplementary Note 54

The concealment method according to any one of supplementary notes 40 to 53, wherein
the device that outputs a response to the second string is trained using the second string, and a string obtained by the concealment means replacing a substring with a string desired as an output of the device for the first string.

### Supplementary Note 55

An estimation method executed by a computer, the method comprising
estimating a fourth string, based on a third string being a response to a second string in which a substring of a first string detected as a concealment target has been replaced with another substring, the fourth string being a response to the first string in which the substring detected as the concealment target has not been replaced.

### Supplementary Note 56

The estimation method according to supplementary note 55, wherein
the estimating includes replacing a substring designated as a replacement string in a substring replacement rule, among substrings of the third string, with a substring designated as a pre-replacement string.

### Supplementary Note 57

The estimation method according to supplementary note 56, wherein
the estimating includes, in a case where there are a plurality of pre-replacement strings for one replacement string in a substring replacement rule, replacing a substring among substrings of the third string designated as a replacement string in the replacement rule, with one of a plurality of strings designated as pre-replacement strings.

### Supplementary Note 58

The estimation method according to supplementary note 57, wherein
the estimating includes inputting data including the first string, the second string, and the third string into a machine learning model to acquire an estimated value of the fourth string, the machine learning model being trained using training data where a fifth string that is a pre-replacement string of a substring detected as a concealment target, a sixth string that is a post-replacement string, and a seventh string that is a response to an input of the sixth string are taken as input data, and an eighth string that is a response to the fifth string is taken as true data.

### Supplementary Note 59

A display method executed by a computer, the method comprising
displaying a second string in which a substring of a first string corresponding to a concealment target has been replaced with another substring.

### Supplementary Note 60

A display method executed by a computer, the method comprising
displaying a fourth string, based on a third string being a response to a second string in which a substring of a first string corresponding to a concealment target has been replaced with another substring, the fourth string being a response to the first string in which the substring corresponding to the concealment target has not been replaced.

### Supplementary Note 61

An estimation method executed by a computer, the method comprising
generating a second string in which a substring of a first string detected as a concealment target has been replaced with another substring; and
estimating a fourth string, based on a third string being a response to a second string, the fourth string being a response to the first string in which the substring detected as the concealment target has not been replaced.

### Supplementary Note 62

The estimation method according to supplementary note 61, wherein
the generating the second string includes replacing the substring of the first string detected as the concealment target, with a hash value of the substring.

### Supplementary Note 63

The estimation method according to supplementary note 61, wherein
the generating the second string includes replacing the substring of the first string detected as the concealment target, with the hash value of a string in which a random string has been appended to the substring.

### Supplementary Note 64

The estimation method according to supplementary note 61, wherein
the generating the second string includes replacing the substring of the first string detected as the concealment target, with a substring in which a predetermined string has been appended to the hash value of the substring.

### Supplementary Note 65

The estimation method according to supplementary note 64, wherein
the device that outputs a response upon receiving an input of the second string, is trained on the predetermined string to be appended to the hash value.

### Supplementary Note 66

The estimation method according to supplementary note 64 or 65, wherein
the generating the second string includes inputting the substring of the first string detected as the concealment target, into a trained machine learning model to acquire the predetermined string.

### Supplementary Note 67

The estimation method according to supplementary note 61, wherein
the generating the second string includes replacing the substring of the first string detected as the concealment target, with a substring obtained by encrypting the substring.

### Supplementary Note 68

The estimation method according to supplementary note 61, wherein
the generating the second string includes replacing the substring of the first string detected as the concealment target, with a substring obtained by encrypting a string in which a random string has been appended to the substring.

### Supplementary Note 69

The estimation method according to supplementary note 61, wherein
the generating the second string includes replacing the substring of the first string detected as the concealment target, with a substring in which a predetermined string has been appended to a string obtained by encrypting the substring.

### Supplementary Note 70

The estimation method according to supplementary note 69, wherein
the device that outputs a response upon receiving an input of the second string, is trained on the predetermined string that has been appended to an encrypted string.

### Supplementary Note 71

The estimation method according to supplementary note 69 or 70, wherein
the generating the second string includes inputting the substring of the first string detected as the concealment target, into a trained machine learning model to acquire the predetermined string.

### Supplementary Note 72

The estimation method according to supplementary note 61, wherein
the generating the second string includes replacing a word detected as a concealment target among words contained in the first string, with another word of the same part of speech.

### Supplementary Note 73

The estimation method according to supplementary note 61, wherein
the generating the second string includes generating a feature vector of the substring of the first string detected as the concealment target, and selecting one of replacement substring candidates based on the generated feature vector.

### Supplementary Note 74

The estimation method according to any one of supplementary notes 61 to 73, wherein
the generating the second string includes employing a manner of replacing a substring of the first string that meets the criteria defined by privacy protection standards.

### Supplementary Note 75

The estimation method according to any one of supplementary notes 61 to 74, wherein
the device that outputs a response to the second string is trained using the second string, and a string obtained by the concealment means replacing a substring with a string desired as an output of the device for the first string.

### Supplementary Note 76

The estimation method according to any one of supplementary notes 61 to 75, wherein
the estimating includes replacing a substring designated as a replacement string in a substring replacement rule, among substrings of the third string, with a substring designated as a pre-replacement string.

### Supplementary Note 77

The estimation method according to any one of supplementary notes 61 to 76, wherein
the estimating includes, in a case where there are a plurality of pre-replacement strings for one replacement string in a substring replacement rule, replacing a substring among substrings of the third string designated as a replacement string in the replacement rule, with one of a plurality of strings designated as pre-replacement strings.

### Supplementary Note 78

The estimation method according to any one of supplementary notes 61 to 77, wherein
the estimating includes inputting data including the first string, the second string, and the third string into a machine learning model to acquire an estimated value of the fourth string, the machine learning model being trained using training data where a fifth string that is a pre-replacement string of a substring detected as a concealment target, a sixth string that is a post-replacement string, and a seventh string that is a response to an input of the sixth string are taken as input data, and an eighth string that is a response to the fifth string is taken as true data.

### Supplementary Note 79

A program that causes a computer to execute:
generating a second string in which a substring of a first string detected as a concealment target has been replaced with another substring; and
inputting the second string to a device that outputs a response to the second string.

### Supplementary Note 80

The program according to supplementary note 79, that causes execution of
the generating the second string including replacing the substring of the first string detected as the concealment target, with a hash value of the substring.

### Supplementary Note 81

The program according to supplementary note 79, that causes execution of
the generating the second string including replacing the substring of the first string detected as the concealment target, with the hash value of a string in which a random string has been appended to the substring.

### Supplementary Note 82

The program according to supplementary note 79, that causes execution of
the generating the second string including replacing the substring of the first string detected as the concealment target, with a substring in which a predetermined string has been appended to the hash value of the substring.

### Supplementary Note 83

The program according to supplementary note 82, wherein
the device that outputs a response upon receiving an input of the second string, is trained on the predetermined string to be appended to the hash value.

### Supplementary Note 84

The program according to supplementary note 82 or 83, that causes execution of
the generating the second string including inputting the substring of the first string detected as the concealment target, into a trained machine learning model to acquire the predetermined string.

### Supplementary Note 85

The program according to supplementary note 79, that causes execution of
the generating the second string including replacing the substring of the first string detected as the concealment target, with a substring obtained by encrypting the substring.

### Supplementary Note 86

The program according to supplementary note 79, that causes execution of
the generating the second string including replacing the substring of the first string detected as the concealment target, with a substring obtained by encrypting a string in which a random string has been appended to the substring.

### Supplementary Note 87

The program according to supplementary note 79, that causes execution of
the generating the second string including replacing the substring of the first string detected as the concealment target, with a substring in which a predetermined string has been appended to a string obtained by encrypting the substring.

### Supplementary Note 88

The program according to supplementary note 87, wherein
the device that outputs a response upon receiving an input of the second string is pre-trained on the predetermined string that has been appended to an encrypted string.

### Supplementary Note 89

The program according to supplementary note 87 or 88, that causes execution of
the generating the second string including inputting the substring of the first string detected as the concealment target, into a trained machine learning model to acquire the predetermined string.

### Supplementary Note 90

The program according to supplementary note 79, that causes execution of
the generating the second string including replacing a word detected as a concealment target among words contained in the first string, with another word of the same part of speech.

### Supplementary Note 91

The program according to supplementary note 79, that causes execution of
the generating the second string including generating a feature vector of the substring of the first string detected as the concealment target, and selecting one of replacement substring candidates based on the generated feature vector.

### Supplementary Note 92

The program according to any one of supplementary notes 79 to 91, that causes execution of
the generating the second string including employing a manner of replacing a substring of the first string that meets the criteria defined by privacy protection standards.

### Supplementary Note 93

The program according to any one of supplementary notes 79 to 92, wherein
the device that outputs a response to the second string is trained using the second string, and a string obtained by the concealment means replacing a substring with a string desired as an output of the device for the first string.

### Supplementary Note 94

A program that causes a computer to execute
estimating a fourth string, based on a third string being a response to a second string in which a substring of a first string detected as a concealment target has been replaced with another substring, the fourth string being a response to the first string in which the substring detected as the concealment target has not been replaced.

### Supplementary Note 95

The program according to supplementary note 94, that causes execution of
the estimating including replacing a substring designated as a replacement string in a substring replacement rule, among substrings of the third string, with a substring designated as a pre-replacement string.

### Supplementary Note 96

The program according to supplementary note 95, that causes execution of
the estimating including, in a case where there are a plurality of pre-replacement strings for one replacement string in a substring replacement rule, replacing a substring among substrings of the third string designated as a replacement string in the replacement rule, with one of a plurality of strings designated as pre-replacement strings.

### Supplementary Note 97

The program according to supplementary note 96, that causes execution of
the estimating including inputting data including the first string, the second string, and the third string into a machine learning model to acquire an estimated value of the fourth string, the machine learning model being trained using training data where a fifth string that is a pre-replacement string of a substring detected as a concealment target, a sixth string that is a post-replacement string, and a seventh string that is a response to an input of the sixth string are taken as input data, and an eighth string that is a response to the fifth string is taken as true data.

### Supplementary Note 98

A program that causes a computer to execute
displaying a second string in which a substring of a first string corresponding to a concealment target has been replaced with another substring.

### Supplementary Note 99

A program that causes a computer to execute
displaying a fourth string, based on a third string being a response to a second string in which a substring of a first string corresponding to a concealment target has been replaced with another substring, the fourth string being a response to the first string in which the substring corresponding to the concealment target has not been replaced.

### Supplementary Note 100

A program that causes a computer to execute:
generating a second string in which a substring of a first string detected as a concealment target has been replaced with another substring; and
estimating a fourth string, based on a third string being a response to a second string, the fourth string being a response to the first string in which the substring detected as the concealment target has not been replaced.

### Supplementary Note 101

The program according to supplementary note 100, that causes execution of
the generating the second string including replacing the substring of the first string detected as the concealment target, with a hash value of the substring.

### Supplementary Note 102

The program according to supplementary note 100, that causes execution of
the generating the second string including replacing the substring of the first string detected as the concealment target, with the hash value of a string in which a random string has been appended to the substring.

### Supplementary Note 103

The program according to supplementary note 100, that causes execution of
the generating the second string including replacing the substring of the first string detected as the concealment target, with a substring in which a predetermined string has been appended to the hash value of the substring.

### Supplementary Note 104

The program according to supplementary note 103, wherein
a device that outputs a response upon receiving an input of the second string is pre-trained on the predetermined string to be appended to the hash value.

### Supplementary Note 105

The program according to supplementary note 103 or 104, that causes execution of
the generating the second string including inputting the substring of the first string detected as the concealment target, into a trained machine learning model to acquire the predetermined string.

### Supplementary Note 106

The program according to supplementary note 100, that causes execution of
the generating the second string including replacing the substring of the first string detected as the concealment target, with a substring obtained by encrypting the substring.

### Supplementary Note 107

The program according to supplementary note 100, that causes execution of
the generating the second string including replacing the substring of the first string detected as the concealment target, with a substring obtained by encrypting a string in which a random string has been appended to the substring.

### Supplementary Note 108

The program according to supplementary note 100, that causes execution of
the generating the second string including replacing the substring of the first string detected as the concealment target, with a substring in which a predetermined string has been appended to a string obtained by encrypting the substring.

### Supplementary Note 109

The program according to supplementary note 100, wherein
a device that outputs a response upon receiving an input of the second string is pre-trained on the predetermined string that has been appended to an encrypted string.

### Supplementary Note 110

The program according to supplementary note 108 or 109, that causes execution of
the generating the second string including inputting the substring of the first string detected as the concealment target, into a trained machine learning model to acquire the predetermined string.

### Supplementary Note 111

The program according to supplementary note 100, that causes execution of
the generating the second string including replacing a word detected as a concealment target among words contained in the first string, with another word of the same part of speech.

### Supplementary Note 112

The program according to supplementary note 100, that causes execution of
the generating the second string including generating a feature vector of the substring of the first string detected as the concealment target, and selecting one of replacement substring candidates based on the generated feature vector.

### Supplementary Note 113

The program according to any one of supplementary notes 100 to 112, that causes execution of
the generating the second string including employing a manner of replacing a substring of the first string that meets the criteria defined by privacy protection standards.

### Supplementary Note 114

The program according to any one of supplementary notes 100 to 113, wherein
a device that outputs a response to the second string is trained using the second string, and a string obtained by the concealment means replacing a substring with a string desired as an output of the device for the first string.

### Supplementary Note 115

The program according to any one of supplementary notes 100 to 114, that causes execution of
the estimating including replacing a substring designated as a replacement string in a substring replacement rule, among substrings of the third string, with a substring designated as a pre-replacement string.

### Supplementary Note 116

The program according to any one of supplementary notes 100 to 115, that causes execution of
the estimating including, in a case where there are a plurality of pre-replacement strings for one replacement string in a substring replacement rule, replacing a substring among substrings of the third string designated as a replacement string in the replacement rule, with one of a plurality of strings designated as pre-replacement strings.

### Supplementary Note 117

The program according to any one of supplementary notes 100 to 116, that causes execution of
the estimating including inputting data including the first string, the second string, and the third string into a machine learning model to acquire an estimated value of the fourth string, the machine learning model being trained using training data where a fifth string that is a pre-replacement string of a substring detected as a concealment target, a sixth string that is a post-replacement string, and a seventh string that is a response to an input of the sixth string are taken as input data, and an eighth string that is a response to the fifth string is taken as true data.

What is claimed is:

1. A concealment device comprising:
at least one memory configured to store instructions; and
at least one processor configured to execute the instructions to:
generate a second string in which a substring of a first string detected as a concealment target has been replaced with another substring; and
input the second string to a device that outputs a response to the second string.

2. The concealment device according to claim 1, wherein the at least one processor is configured to execute the instructions to replace the substring of the first string detected as the concealment target, with a hash value of the substring.

3. The concealment device according to claim 1, wherein the at least one processor is configured to execute the instructions to replace the substring of the first string detected as the concealment target, with the hash value of a string in which a random string has been appended to the substring.

4. The concealment device according to claim 1, wherein the at least one processor is configured to execute the instructions to replace the substring of the first string detected as the concealment target, with a substring in which a predetermined string has been appended to the hash value of the substring.

5. The concealment device according to claim 4, wherein the device that outputs a response upon receiving an input of the second string, is trained on the predetermined string to be appended to the hash value.

6. The concealment device according to claim 4, wherein the at least one processor is configured to execute the instructions to input the substring of the first string detected as the concealment target, into a trained machine learning model to acquire the predetermined string.

7. The concealment device according to claim 1, wherein the at least one processor is configured to execute the instructions to replace the substring of the first string detected as the concealment target, with a substring obtained by encrypting the substring.

8. The concealment device according to claim 1, wherein the at least one processor is configured to execute the instructions to replace the substring of the first string detected as the concealment target, with a substring obtained by encrypting a string in which a random string has been appended to the substring.

9. The concealment device according to claim 1, wherein the at least one processor is configured to execute the instructions to replace the substring of the first string detected as the concealment target, with a substring in which a predetermined string has been appended to a string obtained by encrypting the substring.

10. The concealment device according to claim 9, wherein the device that outputs a response upon receiving an input of the second string, is trained on the predetermined string that has been appended to an encrypted string.

11. The concealment device according to claim 9, wherein the at least one processor is configured to execute the instructions to input the substring of the first string detected as the concealment target, into a trained machine learning model to acquire the predetermined string.

12. The concealment device according to claim 1, wherein the at least one processor is configured to execute the instructions to replace a word detected as a concealment target among words contained in the first string, with another word of the same part of speech.

13. The concealment device according to claim 1, wherein the at least one processor is configured to execute the instructions to generate a feature vector of the substring of the first string detected as the concealment target, and select one of replacement substring candidates based on the generated feature vector.

14. The concealment device according to claim 1, wherein the at least one processor is configured to execute the instructions to employ a manner of replacing a substring of the first string that meets the criteria defined by privacy protection standards.

15. The concealment device according to claim 1, wherein the device that outputs a response to the second string is trained using the second string, and a string obtained by replacing a substring with a string desired as an output of the device for the first string.

16. An estimation system comprising:
at least one memory configured to store instructions; and
at least one processor configured to execute the instructions to:
generate a second string in which a substring of a first string detected as a concealment target has been replaced with another substring; and
estimate a fourth string, based on a third string being a response to a second string, the fourth string being a response to the first string in which the substring detected as the concealment target has not been replaced.

17. The estimation system according to claim 16, wherein the concealment means replaces the substring of the first string detected as the concealment target, with a hash value of the substring.

18. The estimation system according to claim 16, wherein the concealment means replaces the substring of the first string detected as the concealment target, with the hash value of a string in which a random string has been appended to the substring.

19. The estimation system according to claim 16, wherein the concealment means replaces the substring of the first string detected as the concealment target, with a substring in which a predetermined string has been appended to the hash value of the substring.

20. A concealment method executed by a computer, the method comprising
generating a second string in which a substring of a first string detected as a concealment target has been replaced with another substring; and
inputting the second string to a device that outputs a response to the second string.
